(19) United States
(12) Patent Application Publication
(10) Pub. No.: US 2024/0116802 A1
(43) Pub. Date: Apr. 11, 2024

(54) NEAR-INFRARED ABSORBING GLASS AND NEAR-INFRARED CUT FILTER

(71) Applicant: HOYA CORPORATION, Tokyo (JP)

(72) Inventors: Koichi SATO, Tokyo (JP); Yuki SHIOTA, Tokyo (JP); Masashi KANEKO, Tokyo (JP)

(73) Assignee: HOYA CORPORATION, Tokyo (JP)

(21) Appl. No.: 18/533,658

(22) Filed: Dec. 8, 2023

Related U.S. Application Data
(63) Continuation of application No. PCT/JP2022/022956, filed on Jun. 7, 2022.

(30) Foreign Application Priority Data
Jun. 11, 2021 (JP) 2021-098174
Oct. 21, 2021 (JP) 2021-172620
Jan. 12, 2022 (JP) 2022-002975

(51) Int. Cl. C03C 4/08; C03C 3/17; C03C 3/19; G02B 5/22

(52) U.S. Cl. CPC C03C 4/082; C03C 3/17; C03C 3/19; G02B 5/226

(57) ABSTRACT

The near-infrared absorbing glass includes four or more kinds of the prescribed main cations, and includes P ions, Ba ions and Cu ions as essential cations, wherein, in a glass composition expressed in anion %, the content of O ions is 90.0 anion % or more, in a glass composition expressed in atomic %, the ratio of the content of O ions to the content of P ions is 3.15 or less, in a glass composition expressed in mol % based on oxides, the total content of B₂O₃ and SiO₂ is 3.0 mol % or less, the total content of MgO and Al₂O₃ is 8.0 mol % or less, and the total content of Li₂O, Na₂O and K₂O is 15 mol % or less.

### CROSS-REFERENCE TO RELATED APPLICATIONS

This application is a Continuation of PCT International Application No. PCT/JP2022/022956 filed on Jun. 7, 2022, which claims priority under 35 U.S.C. § 119(a) to Japanese Patent Application No. 2021-098174 filed on Jun. 11, 2021, Japanese Patent Application No. 2021-172620 filed on Oct. 21, 2021 and Japanese Patent Application No. 2022-002975 filed on Jan. 12, 2022. Each of the above applications is hereby expressly incorporated by reference, in its entirety, into the present application.

### TECHNICAL FIELD

The present disclosure relates to a near-infrared absorbing glass and a near-infrared cut filter.

### BACKGROUND ART

In modern compact cameras typified by smartphones and the like, not only the obtained image information digitized, but also the image is reconstructed by performing various computational processing on the image information. For example, it has become mainstream to extract a specific object and adjust the color and contrast of the image. In this case, where color information that is not originally present is input to an imaging element due to reflection of light in the optical element, that information needs to be removed, which is undesirable.

A near-infrared cut filter has the function of cutting unnecessary near-infrared light (wavelength 700 nm to 1200 nm) in a sensitivity wavelength range of an imaging element. Generally, the near-infrared cut filter is most often provided in front of the imaging element.

A near-infrared cut filter obtained by using near-infrared absorbing glass as a base material and polishing into a flat-plate shape is widely used.

Near-infrared absorbing glass generally contains Cu ions. FIG. 1 shows an example of a spectral transmission characteristic of a near-infrared absorbing glass.

FIG. 1 does not limit the present disclosure in any way. The light absorption characteristic in the vicinity of wavelengths of 700 nm to 1200 nm is exhibited by Cu ions (Cu²⁺) in the glass. Among such types of glass, glass containing P ions together with Cu ions can show the near-infrared absorption characteristic of Cu ions (Cu²⁺) in a wide wavelength range and is therefore useful as a glass for near-infrared cut filters (see, for example, PTL 1 to 3 (the entire descriptions of which are expressly incorporated herein by reference)).
[PTL 1] JP-A-2019-38719
[PTL 2] CN110255897
[PTL 3] JP-A-55-3336

### SUMMARY

In the transmittance curve beyond a wavelength of 600 nm in FIG. 1, the wavelength at which the transmittance is 50% is called “half value”, which is one of the main standards for near-infrared cut filters. The half value varies depending on the filter specifications but is often set within the wavelength range of 600 nm to 650 nm. As a general method for setting the half value to a desired value, there is a method of adjusting either the plate thickness of the glass base material or the concentration of Cu ions (Cu²⁺) in the glass according to the Lambert-Beer law.

The near-infrared cut filter is also required to have an excellent ability to cut near-infrared light (that is, has a low transmittance of near-infrared light while having a desired half value) and to have a high transmittance in the visible range (violet region to red region).

In addition, in recent years, there has been a demand for both miniaturization and high performance in imaging element modules mounted on smartphones and the like, and near-infrared cut filters have been required to have a smaller plate thickness. Accordingly, the thickness of the near-infrared absorbing glass has been reduced in recent years from the conventional thickness of 1 mm to about 0.45 mm, 0.3 mm, or 0.2 mm, and it is also desired to reduce the thickness to the order of 0.1 mm.

Where the thickness of the near-infrared absorbing glass is simply reduced, the optical density of CuO (number of moles×thickness) required for near-infrared absorption decreases, resulting in a decrease in near-infrared absorption efficiency. In order to solve the above, it is conceivable to increase the amount of CuO. However, simply increasing the amount of CuO tends to reduce the transmittance on the short wavelength side, making it difficult to maintain both transmittance in the visible range (purple region to red region) and near-infrared absorption.

Furthermore, in order to provide a near-infrared cut filter that is suitable for use in high-temperature and high-humidity environments, it is desirable that deterioration of the near-infrared absorbing glass in weather resistance in high-temperature and high-humidity environments be suppressed. However, according to the study of the present inventors, it is not easy to maintain both the transmittance in the visible region (purple region to red region) and the absorption of near-infrared rays, and to suppress the decrease in weather resistance.

In view of the above, one aspect of the present disclosure provides for a near-infrared absorbing glass that has high transmittance in the visible region (purple region to red region) even when reduced in thickness, is excellent in near-infrared cutting ability, and makes it possible to suppress the decrease in weather resistance, and also provides a near-infrared cut filter comprised of such near-infrared absorbing glass.

One aspect of the present disclosure relates to a near-infrared absorbing glass (hereinafter also referred to as “glass 1”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio of the content of O ions to the content of P ions (O ions/P ions) (hereinafter also referred to as “O/P ratio”) is 3.15 or less,
in a glass composition expressed in mol % based on oxides,
the total content of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
the content of CuO is α₁% or more,
α₁ is a value calculated by the following formula 1:

α₁=70400×exp(−2.855×R) (Formula 1)
in formula 1,
R is the ratio (O ions/P ions).

One aspect of the present disclosure relates to a near-infrared absorbing glass (hereinafter also referred to as “glass 2”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio of the content of 0 ions to the content of P ions (O ions/P ions) is 3.15 or less,
in a glass composition expressed in mol % based on oxides,
the total content of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
the following formula 2 is satisfied:

C−3200×exp(−2.278×R)≥0 (Formula 2)
in formula 2,
C is the CuO content per molar volume of the glass (unit: mmol/cc),
R is the ratio (O ions/P ions).

One aspect of the present disclosure relates to a near-infrared absorbing glass (hereinafter also referred to as “glass 3”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio (O ions/P ions) of the content of O ions to the content of P ions is 3.15 or less,
in a glass composition expressed in mol % based on oxides,
the total content of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
A₁ calculated by the following formula 3 is 2500 or more:

A₁={O(P)—O(others)}×Cu (Formula 3)
in formula 3,
O(P) indicates the amount of oxygen that constitutes oxides of P ions in the glass composition based on oxides,
O (others) indicates the amount of oxygen obtained by excluding the O (P) from the amount of oxygen constituting the oxides of the main cations in the glass composition based on oxides, and
Cu indicates the CuO content in mol % in the glass composition based on oxides.

One aspect of the present disclosure relates to a near-infrared absorbing glass (hereinafter also referred to as “glass 4”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio of the content of 0 ions to the content of P ions (O ions/P ions) is 3.15 or less,
in a glass composition expressed in mol % based on oxides,
the total content of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
A₂ calculated by the following formula 4 is 700 or more:

A₂={O(P)—O(others)}×C (Formula 4)
in formula 4,
C is the CuO content per molar volume of the glass (unit: mmol/cc),
O(P) indicates the amount of oxygen that constitutes oxides of P ions in the glass composition based on oxides, and
O(others) indicates the amount of oxygen obtained by excluding the O (P) from the amount of oxygen constituting the oxides of the main cations in the glass composition based on oxides.

One aspect of the present disclosure relates to a near-infrared absorbing glass (hereinafter also referred to as “glass 5”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio of the content of 0 ions to the content of P ions (O ions/P ions) is 3.15 or less,
in a glass composition expressed in mol % based on oxides,
the total content (B₂O₃+SiO₂) of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
the content of CuO is α₂% or more,
α₂ is a value calculated by the following formula 5:

α2=76522×exp(−2.855×R) (Formula 5)
in formula 5,
R is the ratio (O ions/P ions).

One aspect of the present disclosure relates to a near-infrared absorbing glass (hereinafter also referred to as “glass 6”),
which includes four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
includes P ions, Ba ions and Cu ions as essential cations, wherein
in a glass composition expressed in anion %, the content of O ions is 90.0 anion % or more,
in a glass composition expressed in atomic %, the ratio of the content of 0 ions to the content of P ions (O ions/P ions) is 3.15 or less,
in a glass composition expressed in mol % based on oxides,
the total content of B₂O₃ and SiO₂ (B₂O₃+SiO₂) is 3.0 mol % or less,
the total content of MgO and Al₂O₃ (MgO+Al₂O₃) is 8.0 mol % or less,
the total content of Li₂O, Na₂O and K₂O (Li₂O+Na₂O+K₂O) is 15 mol % or less, and
the following formula 6 is satisfied:

C−3478×exp(−2.278×R)≥O (Formula 6)
in formula 6,
C is the CuO content per molar volume of the glass (unit: mmol/cc),
R is the ratio (O ions/P ions).

One aspect of the present disclosure relates to a near-infrared absorbing glass (hereinafter also referred to as “glass 7”), wherein
in a glass composition expressed in mol % based on oxides,
the P₂O₅ content is 40.0 mol % to 65.0 mol %,
the CuO content is 9.0 mol % to 25.0 mol %,
the BaO content is 5.0 mol % to 50.0 mol %,
the total content of Li₂O, Na₂O and K₂O (Li₂O+Na₂O+K₂O) is 1.0 mol % to 15.0 mol %,
the SiO₂ content is 2.0 mol % or less,
the B₂O₃ content is 2.0 mol % or less,
the Al₂O₃ content is 0.5 mol % or more and 7.0 mol % or less,
the Li₂O content is 7.0 mol % or less,
the ZnO content of 10.0 mol % or less,
the PbO content is 2.0 mol % or less,
the ratio of the MgO content to the total content of MgO, CaO, SrO and BaO (MgO/(MgO+CaO+SrO+BaO)) is 0.3 or less,
in a glass composition expressed in atomic %, the ratio of the content of 0 ions to the content of P ions (O ions/P ions) is 3.50 or less, and
in a glass composition expressed in atomic %, the content of F ions is 10.0 anion % or less.

One aspect of the present disclosure relates to a near-infrared absorbing glass (hereinafter also referred to as “glass 8”) having
a transmittance characteristic in which the external transmittance at a wavelength of 400 nm is 75% or more and the external transmittance at a wavelength of 1200 nm is 7% or less in terms of a thickness at which the external transmittance is 50% at a wavelength of 620 to 650 nm at a thickness of 0.25 mm or less, and having
an average linear expansion coefficient at 100° C. to 300° C. of 135×10⁻⁷/K or less.

According to one aspect of the present disclosure, it is possible to provide a near-infrared absorbing glass that has high transmittance in the visible region (purple region to red region) even when reduced in thickness, is excellent in near-infrared cutting ability, and makes it possible to suppress the decrease in weather resistance. Further, according to one aspect of the present disclosure, it is possible to provide a near-infrared cut filter comprised of such near-infrared absorbing glass.

### BRIEF DESCRIPTION OF DRAWINGS

FIG. 1 shows an example of a spectral transmission characteristic of a near-infrared absorbing glass.

FIG. 2 shows photographs of exterior of glasses of Examples 1-1 to 1-4.

FIG. 3 shows a graph in which the value of T400 is plotted against the amount of Sb₂O₃ for the glasses of Example 1 and Examples 1-1 to 1-4.

FIG. 4 shows photographs of exterior of glasses of Examples 4-1 to 4-4.

FIG. 5 shows a graph in which the value of T400 is plotted against the amount of Sb₂O₃ for the glasses of Example 4 and Examples 4-1 to 4-4.

FIG. 6 shows photographs of exterior of glasses of Examples 25-1 to 25-4.

FIG. 7 shows a graph in which the value of T400 is plotted against the amount of Sb₂O₃ for the glasses of Example 25 and Examples 25-1 to 25-4.

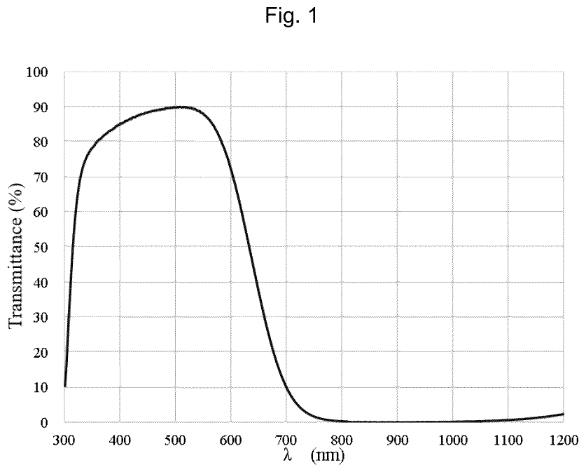

### DESCRIPTION OF EMBODIMENTS

[Near-Infrared Absorbing Glass]

In the following, glasses 1 to 8 are collectively referred to simply as “glass” or “near-infrared absorbing glass”. References to glass compositions and physical properties apply to all glasses 1 to 8 unless otherwise specified.

In the present disclosure and present description, a near-infrared absorbing glass is a glass that has the property of absorbing light with a wavelength in at least the entire region of near-infrared wavelength range (wavelength of 700 nm to 1200 nm) or part thereof. Further, the near-infrared absorbing glass according to one aspect of the present disclosure can contain O ions as constituent ions, and thus can be an oxide glass. An oxide glass is a glass in which the main network-forming components of the glass are oxides. Further, the near-infrared absorbing glass according to one aspect of the present disclosure can contain P ions (cations) together with O ions (anions) as constituent ions, and therefore can be a phosphate glass. The O ion is an anion of an oxygen atom and is also generally called an oxide ion.

Glasses 1 to 8 will be described in more detail below.

<Glass Composition>

### (Analysis Method)

For various components constituting the glass, the content of elements contained in the glass (% by mass of the elements) can be quantified by known methods such as inductively coupled plasma atomic emission spectrometry (ICP-AES), inductively coupled plasma mass spectrometry (ICP-MS), and the like.

Anion components contained in the glass can be identified and quantified by known analytical methods such as ion chromatography, non-dispersive infrared absorption spectroscopy (ND-IR), and the like.

In the present disclosure and present description, when the content of a component is 0%, or the component is not contained or not introduced means that this component is not substantially included, and this component is allowed to be included at the level of unavoidable impurities.

(Notation of Glass Composition Based on Oxides)

Based on the results obtained from the above analysis, it is possible to calculate the content (unit: mol %) of each component in the glass composition based on oxides. A specific method is as follows.

By dividing the content of element i obtained by the above analysis method (% by mass Pᵢ of element) by the atomic weight Mᵢ of element i, the number of moles nᵢ=Pᵢ/Mᵢ of each element is obtained.

When the element i is a cation component A₁, the number of moles nᵢ of the element obtained above is replaced with the number of moles n′ᵢ of the corresponding oxide. Specifically, when the composition formula of the oxide of the cation component Aᵢ corresponding to the element i is represented by AᵢxOy, n′ᵢ=nᵢ/x.

When the element i is an anion component Bi other than O ion, the corresponding number of moles nᵢ of the element is hereinafter referred to as mᵢ.

The content PAᵢ (mol %) of the cation component A₁ as the oxide AᵢxOy in the glass composition based on oxides is represented by

PAᵢ=n′ᵢ/(Σn′ᵢ+Σmᵢ)×100.

The content in the glass composition based on oxides can also be referred to as an oxide-based fraction.

In the glass composition based on oxides, the oxide-based fraction PBᵢ (mol %) of the anion component Bi other than O ions is represented by

PBᵢ=m′ᵢ/(Σn′ᵢ+Σmᵢ)×100.

Here, Σn′ᵢ is the total number of moles of the oxide AᵢxOy of cation component contained in the glass. However, depending on the effective number of the content, ignoring a trace component does not affect the calculation result.

(Anion %)

“Anion %” is a value calculated by “(content of anion i of interest expressed in mol %)/(total number of anions contained in glass expressed in mol %)×100”, and means the molar percentage of the amount of anion of interest in the total amount of anions.

The anion % of O ions based on the above description of the notation of the glass composition based on oxides can be calculated by

(ΣOᵢ−Σ(Nₖ/2)Bₖ)/(ΣOᵢ−Σ(Nₖ/2)Bₖ+ΣBₖ)×100

where the composition formula of the oxide of the cation component Al corresponding to the element i is represented by AᵢxOy, the number of O contained in the oxide of the cation component A₁ is defined as Oᵢ=PAᵢ×y by using the oxide-based fraction PAᵢ (mol %) of the cation component A₁, and the valence of the anion component Bₖ is denoted by Nₖ.

Here, ΣOᵢ is the total number of moles of O ions in the glass composition based on oxides, and Σ(Nₖ/2)Bₖ represents the number of moles of O ions substituted by the anion component Bₖ. The numerator (ΣOᵢ−7(Nₖ/2)Bₖ) of the formula is the number of moles of O ions contained in the glass.

Meanwhile, regarding the content of oxygen in the present disclosure and the present description, when no anion component other than oxygen is detected by analysis by a known method, all of the anion components (that is, 100 anion %) are assumed to be O ions.

(Cation Components)

For the valence of the cation components, the formal valence of each cation is used. The formal valence is the valence necessary for the oxide to maintain electrical neutrality when the valence of the O ion constituting the oxide is −2 for the oxide of the cation of interest. The formal valence can be determined uniquely from the chemical formula of the substance.

For example, for Cu ions, the valence of Cu is +2 in order to maintain electrical neutrality between O²⁻ and Cu included in the chemical formula of oxide CuO. Further, for example, for P ions, the valence of P is +2×5/2=+5 in order to maintain electrical neutrality between O²⁻ and P included in the chemical formula of oxide P₂O₅. Generalizing this, the formal valence of the cation Ai contained in the oxide AixOy is “+2y/x”. Therefore, when analyzing the glass composition, it is not necessary to analyze the valence of cations.

Also, the valence of the anion (for example, the valence of O ion is −2) is also a formal valence based on the idea that the O ion accepts two electrons and takes a closed shell structure. Therefore, when analyzing the glass composition, it is not necessary to analyze the valence of the anion. Also, some of Cu²⁺ can become Cu⁺ during melting, but the amount thereof is usually very small, so the valence of the entire Cu can be considered to be +2.

<Glasses 1 to 6>

### (Anion Components)

Glasses 1 to 6 contain at least O ions as anions, and the content thereof is 90.0 anion % or more in the glass composition expressed in anion %. The present inventors presume that by lowering the O/P ratio in a glass mainly composed of O ions as anions in this way, the absorption by CuO in the red region can be shifted to the longer wavelength side, thereby making it possible to increase the content ratio of CuO and improve the near-infrared cutting ability without reducing the transmittance in the red region. In glasses 1 to 6, the O ion content in the glass composition expressed by anion % is 90.0% or more, can be 95.0% or more, 98.0% or more, or 99.0% or more. A high proportion of O ions in the anion component is also preferable for suppressing volatilization during melting of the glass. Suppressing the volatilization during melting of the glass is preferable from the viewpoint of suppressing the generation of striae. In particular, the content of O ions can be 100% from the viewpoint of suppressing volatilization during melting of the glass, enhancing productivity, and suppressing the generation of harmful gases during production. The formal valence of O ions is −2.

The glasses 1 to 6 can contain only O ions as anions in one embodiment, and can contain one or more other anions together with O ions in another embodiment. Examples of other anions include F ions, Cl ions, Br ions, I ions, and the like. The formal valence of F ions, Cl ions, Br ions, and I ions is −1.

From the viewpoint of improving the homogeneity and strength of the glass, the content of F ions can be 15.0 anion % or less, 10.0 anion % or less, 5.0 anion % or less, 2.0 anion % or less, or 1.0 anion % or less in the glass composition expressed in anion %. In particular, from the viewpoint of suppressing volatilization during melting of the glass, enhancing productivity, and suppressing the generation of harmful gases during production, glasses 1 to 6 can also contain no F ions.

(O/P Ratio)

In the glass composition expressed in atomic %, the ratio of the cation content and the anion content is the ratio of the contents (expressed in atomic %) of the components of interest when the total amount of all cation components and all anion components is 100 atomic %. Therefore, the ratio of the content of O ions to the content of P ions (O ions/P ions) is the ratio of the content (expressed in atomic %) of O ions to the content (expressed in atomic %) of P ions when the total amount of all cation components and all anion components is 100 atomic %.

O/P Ratio Calculation Method 1

A method for calculating the O/P ratio (also referred to as R) will be described by taking as an example a glass having the following composition as a glass composition based on oxides.

P₂O₅: 52.6 mol, Al₂O₃: 2.6 mol, K₂O: 2.7 mol, BaO: 21.6 mol, ZnO: 4.2 mol, CuO: 16.3 mol.

The number of O atoms included in the molecular formula is 5 for P₂O₅, 3 for Al₂O₃, 1 for K₂O, 1 for BaO, 1 for ZnO, and 1 for CuO.

The number of moles of O included in the molecular formula is 263.0 for P₂O₅, 7.8 for Al₂O₃, 2.7 for K₂O, 21.6 for BaO, 4.2 for ZnO, and 16.3 for CuO.

The O/P ratio of the glass in the above example can be obtained as follows.

The number Nₛ of O ions in the molecular formula of glass: 52.6 P₂O₅ —2.6 Al₂O₃— 2.7 K₂O—21.6 BaO—4.2 ZnO—16.3 CuO is found. The molecular formula of glass is a compositional formula of glass represented so that the total number of molecules contained in the glass is 100. That is, using the number of O ions (P₂O₅: 5, Al₂O₃: 3, K₂O: 1, BaO: 1, ZnO: 1, CuO: 1) contained in the molecular formula MxOy of each oxide, Nₛ is calculated as

N_{S}=52.6×5+2.6×3+2.7×1+21.6×1+4.2×1+16.3×1=315.7.

In the glass of the above example, the number of O ions substituted by other anions in the molecular formula of the glass is zero. By dividing N_{S}=315.7 by the number of moles 52.6×2 of P contained in P₂O₅, O/P ratio=315.7/(52.6×2)=3.00 . . . is obtained.

O/P Ratio Calculation Method 2

When one or more other anion components are detected in addition to oxygen by analysis by a known method, the content (unit: anion %) calculated by the method of (3) below from (1) the content of cations based on the valence of the cation components contained in the glass and the mol % of the elements and (2) the content of anions based on the valence of the anion components other than oxygen and the mol % of the elements can be used as the content of oxygen.

That is, from the results of identification and quantitative analysis by known methods,
(1) the total U of “the number of oxygens per one cation (y/x)×the content of the cation based on mol % of the element, where the number of oxygens is denoted by y and the number of cations is denoted by x in an oxide MxOy” is calculated for cation components contained in the glass,
(2) the total V of “content of the anion based on mol % of the element×the number of substituted oxygens (z/2) per one anion” is calculated for anion components other than oxygen based on results of identification and quantification analysis using known methods and the valence z of anions, and
(3) the value of U-V can also be used as the content of O ions relative to the content of the P ions.

Calculation example 1 and calculation example 2 below are shown as calculation examples of the calculation method 2.

Calculation example 1: when the molar percentages of the elements of P ions, Li ions, and Cu ions are quantified as 22.0, 8.0, and 5.5 (contents expressed in mol % of the elements), y/x of the corresponding oxides: P₂O₅, Li₂O and CuO are 2.5, 0.5 and 1.0, respectively, and therefore, it is determined that

U=22×2.5+8×0.5+5.5×1.0=64.5, and

V=0.

Therefore, the molar percentage of O ions based on the molar percentage of the element is 64.5 (the content expressed in mol % of the element).

The O/P ratio=64.5/22=2.93 . . . can be obtained from the ratio of the O ion value obtained in this way and the analyzed molar percentage of P ions.

Calculation example 2: when the molar percentages of the elements of P ions, Li ions, and Cu ions are quantified as 22.0, 8.0, and 5.5 (contents expressed in mol % of the elements), and the molar percentage of the element of F ions is quantified as 4.0 (content expressed in mol % of the element), the y/x values of the corresponding oxides: P₂O₅, Li₂O and CuO are 2.5, 0.5 and 1.0, respectively, and since the valence of F is −1, it is determined that

U=22×2.5+8×0.5+5.5×1.0=64.5, and

V=4×½=2.

Therefore, the molar percentage of O ions based on the molar percentage of the element is 62.5 (the content expressed in mol % of the element).

The O/P ratio=62.5/22=2.84 . . . can be obtained from the ratio of the O ion value obtained in this way and the analyzed molar percentage of P ions.

In glasses 1 to 6, from the viewpoint of improving both the transmittance in the visible region and the near-infrared cutting ability, and also from the viewpoint of improving the thermal stability of the glass, the ratio of the content of O ions to the content of P ions (O/P ratio) in the glass composition expressed in atomic % is 3.15 or less.

In glass 1 to glass 6, the O/P ratio can be 3.14 or less, 3.13 or less, 3.12 or less, 3.11 or less, or 3.10 or less.

Meanwhile, from the viewpoint of improving the weather resistance and/or suppressing the deterioration of meltability, it is preferable that the O/P ratio be large in glass 1 to glass 6. From this point of view, in glass 1 to glass 6, the O/P ratio can be 2.85 or more, 2.86 or more, 2.87 or more, 2.88 or more, 2.89 or more, 2.90 or more, or 3.00 or more.

(Cation Component)

Glasses 1 to 6 include four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, while including P ions, Ba ions and Cu ions as essential cations. In one embodiment, the total content of oxides of the main cations can be 90.0% or more in the glass compositions (expressed in mol %) of glasses 1 to 6 based on oxides.

In glasses 1 to 6, where the total content of oxides of the main cations is 90.0% or more, it can contribute to improving the thermal stability of the glass and/or to improving the optical homogeneity of the glass by suppressing striae, volatilization, and the like. From the above points of view, the total content of oxides of the main cations in glasses 1 to 6 can be 92.0% or more, 93.0% or more, 95.1% or more, 96.1% or more, 97.1% or more, 98.1% or more, 98.6% or more, 99.1% or more, or 99.6% or more, and can be 100%. In one embodiment, the total content of oxides of the main cations in glasses 1 to 6 can be 100% or less, or 99.5% or less, 99% or less, 98.5% or less, 98.0% or less, and 97.5% or less.

The content of the cation components will be described below as the content in the glass composition (expressed in mol %) based on oxides.

Since CuO is an essential component for imparting near-infrared cutting ability to glass, glasses 1 to 6 contain Cu ion as an essential cation.

In glass 1, the CuO content is α₁% or more. α₁ is a value calculated by formula 1 below.

α₁=70400×exp(−2.855×R) (Formula 1)

In formula 1, R is the O/P ratio.

In addition, for glass 2, the lower limit of the CuO content is defined by the following formula 2 based on the CuO content ratio per molar volume of the glass.

C−3200×exp(−2.278×R)≥0 (Formula 2)

In formula 2, C is the CuO content (unit: mmol/cc) per molar volume of the glass and R is the O/P ratio.

In formula 2, the C is obtained by the following method.

C can be calculated as

C=mol % of CuO/(M/D)×1000(unit:mmol/cc)

by measuring the specific gravity value D (g/cc) of the glass, obtaining the mass corresponding to 1 mol of the glass composition, that is, the molar molecular weight M (g/mol), on the basis of the glass composition obtained by analysis as described above, and obtaining the molar volume M/D (unit: cc/mol) of the glass.

The molar molecular weight M can be obtained as

M={Σ(PAᵢ×MAᵢ)+Σ(PBₖ×MBₖ)−Σ(Nₖ/2)Mₒ}/ΣPAᵢ

on the basis of the above description of the notation of the glass composition based on oxides, when the formula weight of the oxide corresponding to the above cation component A₁ is denoted by MAᵢ, the atomic weight of the anion component Bₖ is denoted by MBₖ, and the atomic weight of oxygen is denoted by Mₒ.

For example, when the glass composition is composed of s mol % of an A₂O component based on oxide, t mol % of a BO component based on oxide, and u mol % of F component, and s+t+u=100 (%), the formula weight of the A₂O component is denoted by M_{A} (g/mol), the formula weight of the BO component is denoted by MB (g/mol), the atomic weight of F is denoted by M_{F} (g/mol), and the atomic weight of oxygen is denoted by Mₒ (g/mol),

M=(s×M_{A}+t×M_{B}+u×M_{F}−u/2×Mₒ)/(s+t).

For example, a method for calculating the molar molecular weight M will be explained for an example of glass with the following glass composition based on oxides: P₂O₅: 52.6 mol %, Al₂O₃: 2.6 mol (g/mol), K₂O: 2.7 mol (g/mol), BaO: 21.6 mol (g/mol), ZnO: 4.2 mol (g/mol), and CuO: 16.3 mol (g/mol).

By using the formula weight of P₂O₅: 141.94 (g/mol),
the formula weight of Al₂O₃: 101.96 (g/mol),
the formula weight of K₂O: 94.2 (g/mol),
the formula weight of BaO: 153.3 (g/mol),
the formula weight of ZnO: 81.4 (g/mol), and
the formula weight of CuO: 79.55 (g/mol),
M=(52.6×141.94+2.6×101.96+2.7×94.2+21.6×153.3+4.2×81.4+16.3×79.55)/(52.6+2.6+2.7+21.6+4.2+16.3)=129.36 (g/mol) can be calculated.

As a result of extensive studies, the present inventors have newly found that where the O/P ratio is lowered in a glass mainly composed of O ions as anions, the absorption by CuO in the red region shifts to the longer wavelength side, thereby making it possible to increase the CuO content while suppressing the decrease in the transmittance in the red region. Furthermore, the present inventors have newly found that there is a good correlation between the O/P ratio and the CuO content for achieving a prescribed half value at a prescribed thickness, and have arrived at defining the lower limits of the CuO content (α₁, α₂) by formula 1 for glass 1 for which the O/P ratio is in the range described above and by formula 5 for glass 5. The present inventors have also arrived at defining the CuO content ratio per molar volume of the glass for which the O/P ratio is in the range described above by formula 2, and by formula 6 for glass 6.

In glass 3, the CuO content is defined based on A₁ calculated by formula 3 below, and A₁ is 2500 or more.

A₁={O(P)—O(others)}×Cu (Formula 3)

In formula 3, O (P) indicates the amount of oxygen that constitutes oxides of P ions in the glass composition based on oxides, O (others) indicates the amount of oxygen obtained by excluding the O (P) from the amount of oxygen constituting the oxides of the main cations described above for glass 3 in the glass composition based on oxides, and Cu indicates the CuO content expressed in mol % in the glass composition based on oxides.

“O (P)” in formula 3 is calculated as follows.

When the P₂O₅ content in the glass composition (expressed by mol %) based on oxides is M mol %, O (P) can be calculated as “O (P)=M×5” by using the number of oxygen atoms contained in the chemical formula of P₂O₅, which is 5.

Similarly, for the main cations other than P ions, the amount of oxygen constituting the oxide of each cation is calculated using the value of the content as an oxide in the glass composition (expressed in mol %) based on oxides and the number of oxygen atoms contained in the oxide formed by each cation in the state of formal valence.

“O (others)” is calculated as a value obtained by subtracting O (P) from the total amount of oxygen thus calculated for the oxides of the main cations.

When the CuO content in the glass composition (expressed in mol %) based on oxides is N mol %, “A” is calculated as A₁={O (P)—O (others)}× N.

As described above, the present inventors have newly found that where the O/P ratio is reduced in a glass mainly composed of O ions as anions, the absorption by CuO in the red region shifts to the longer wavelength side, thereby making it possible to increase the CuO content while suppressing the decrease in the transmittance in the red region. Furthermore, new information that by configuring the chemical species other than P—O that is coordinated to CuO with chemical species that have a smaller ionic radius and a lower valence, the following (1) and (2) will result in increased transmittance in the visible region (purple region to red region) was also obtained. For glass 3, based on this information, the CuO content is defined based on A calculated by formula 3.
(1) The transmittance in the red region can be increased by shifting the absorption derived from Cu²⁺ to longer wavelength.
(2) The generation of Cu⁺, which causes absorption in the violet region near a wavelength of 400 nm, can be suppressed by making it possible to bring the glass into a liquid state at a low temperature.

Regarding glass 3, from the viewpoint of improving both the transmittance in the visible region and the near-infrared cutting ability, A₁ is 2500 or more, can be 2800 or more, 2900 or more, 3000 or more, 3100 or more, 3200 or more, 3300 or more, 3400 or more, 3500 or more, 3600 or more, 3700 or more, 3800 or more, 3900 or more, 4000 or more, 4100 or more, 4200 or more, 4300 or more, 4400 or more, 4500 or more, 4600 or more, 4700 or more, 4800 or more, 4900 or more, 5000 or more, 5100 or more, 5200 or more, 5300 or more, 5400 or more, 5500 or more, 5600 or more, 5700 or more, 5800 or more, 5900 or more, 6000 or more, 6100 or more, 6200 or more, 6300 or more, 6400 or more, or 6500 or more. Meanwhile, from the viewpoint of further suppressing a decrease in thermal stability of the glass due to a large amount of Cu and O, a decrease in transmittance at the desired half-value wavelength, and/or a decrease in thermal stability or weather resistance of the glass due to too little O (others), A can be 20,000 or less, 19,000 or less, 18,000 or less, 17,000 or less, 16,000 or less, 15,000 or less, 14,000 or less, 13,000 or less, 12,000 or less, 11,000 or less, 10,000 or less, 9000 or less, or 8000 or less. There tends to be a preference for a larger numerical value in order to achieve the desired half value with a smaller thickness.

In glass 4, the CuO content is defined based on A₂ calculated by the following formula 4, and A₂ is 700 or more.

A₂={O(P)—O(others)}×C (Formula 4)

In formula 4, C is the CuO content per molar volume of the glass (unit: mmol/cc), O (P) indicates the amount of oxygen that constitutes oxides of P ions in the glass composition based on oxides, and O (others) indicates the amount of oxygen obtained by excluding the O (P) from the amount of oxygen constituting the oxides of the main cations in the glass composition based on oxides.

Regarding glass 4, from the viewpoint of improving both the transmittance in the visible region and the near-infrared cutting ability, A₂ is 700 or more, can be 800 or more, 850 or more, 890 or more, 1000 or more, 1100 or more, 1200 or more, 1300 or more, 1400 or more, 1500 or more, 1600 or more, 1700 or more, or 1800 or more. Meanwhile, from the viewpoint of further suppressing a decrease in thermal stability of the glass due to a large amount of Cu and O, a decrease in transmittance at the desired half-value wavelength, and/or a decrease in thermal stability or weather resistance of the glass due to too little O (others), A₂ can be 5000 or less, 4000 or less, 3500 or less, 3000 or less, 2500 or less, or 2000 or less. There tends to be a preference for a larger numerical value in order to achieve the desired transmittance half value with a smaller thickness.

Also, in glass 5, the CuO content is α₂% or more. α₂ is a value calculated from formula 5 below.

α2=76522×exp(−2.855×R) (Formula 5)

In formula 5, R is the O/P ratio.

In addition, for glass 6, the lower limit of the CuO content is defined by the following formula 6 based on the CuO content ratio per molar volume of the glass.

C−3478×exp(−2.278×R)≥O (Formula 6)

In formula 6, C is the CuO content per molar volume of the glass (unit: mmol/cc), and R is the O/P ratio.

In the glass composition (expressed in mol %) based on oxides, the CuO content of glasses 1 to 6 can be 4.0% or more, 5.0% or more, 6.0% or more, 7.0% or more, 7.5% or more, 8.0% or more, 8.5% or more, 9.0% or more, 9.5% or more, 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more. From the viewpoint of leaving room for introducing glass-forming components and maintaining the thermal stability of the glass, the CuO content can be 48.0% or less, 47.0% or less, 46.0% or less, 45.0% or less, 44.0% or less, 43.5% or less, 43.0% or less, 42.5% or less, 42.0% or less, 41.5% or less, 41.0% or less, 40.5% or less, 40.0% or less, 39.5% or less, 39.0% or less, 38.5% or less, 38.0% or less, 37.5% or less, 37.0% or less, 36.5% or less, 36.0% or less, 35.5% or less, 35.0% or less, 34.5% or less, 34.0% or less, 33.5% or less, 33.0% or less, 32.5% or less, 32.0% or less, 31.5% or less, or 31.0% or less.

In order for the wavelength λ_{T}50, at which the external transmittance including the reflection loss is 50%, to be in the range of 600 nm to 650 nm as a transmittance characteristic in terms of a thickness of 0.16 mm, the CuO content in the glass composition (expressed in mol %) based on oxides can be 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the wavelength λ_{T}50, at which the external transmittance including the reflection loss is 50%, to be in the range of 600 nm to 650 nm as a transmittance characteristic in terms of a thickness of 0.21 mm, the CuO content in the glass composition (expressed in mol %) based on oxides can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the wavelength λ_{T}50, at which the external transmittance including the reflection loss is 50%, to be in the range of 600 nm to 650 nm as a transmittance characteristic in terms of a thickness of 0.25 mm, the CuO content in the glass composition (expressed in mol %) based on oxides can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

Meanwhile, regarding the transmittance characteristic in terms of a thickness of 0.25 mm, where the CuO content is large, the wavelength λ_{T}50, at which the external transmittance including the reflection loss is 50%, can be less than 600 nm. Therefore, the CuO content can be 35.0% or less, 34.0% or less, 33.0% or less, 32.0% or less, 31.0% or less, 30.0% or less, 29.5% or less, 29.0% or less, 28.5% or less, 28.0% or less, 27.5% or less, 27.0% or less, 26.5% or less, 26.0% or less, 25.5% or less, 25.0% or less, 24.5% or less, 24.0% or less, 23.5% or less, 23.0% or less, 22.5% or less, 22.0% or less, 21.5% or less, 21.0% or less, 20.5% or less, or 20.0% or less.

In order for the glass thickness at which the wavelength λ_{T}50, at which the external transmittance including the reflection loss at a wavelength of 550 nm or more is 50%, becomes 645 nm to be 0.25 mm or less, in the glass composition (expressed in mol %) based on oxides, the CuO content can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the glass thickness at which the wavelength λ_{T}50, at which the external transmittance including the reflection loss at a wavelength of 550 nm or more is 50%, becomes 633 nm to be 0.25 mm or less, in the glass composition (expressed in mol %) based on oxides, the CuO content can be 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In glass 2 and glass 4, the value of C can be 4.0 or more, 4.1 or more, or 4.2 or more. From the viewpoint of leaving room for introducing glass-forming components and maintaining the thermal stability of the glass, the value of C can be 8.5 or less, 8.0 or less, 7.5 or less, 7.0 or less, 6.5 or less, 6.0 or less, or 5.5 or less.

In glasses 1 to 6, the CuO content can be α₃% or more. α₃ is a value calculated from formula 7 below. In one embodiment, for glasses 7 and 8, the CuO content can be 03% or more.

α₃=(70400×0.25/d)×exp(−2.855×R) (Formula 7)

In formula 7, R is the O/P ratio. d can take a value greater than 0 and 0.25 or less. For example, d is 0.25, 0.24, 0.23, 0.22, 0.21, 0.20, 0.19, 0.18, 0.17, 0.16, 0.15, 0.14, 0.13, 0.12, 0.11, 0.10, 0.09, 0.08, 0.07, 0.06, 0.05, 0.04, 0.03, 0.02, 0.01, and the like. However, the value of d is not limited to these. Small values of d tend to be preferred in order to achieve the desired transmittance half value at a smaller thickness.

For example, when d=0.11, the CuO content can be α₃% or more, and α₃ is calculated by the following formula.

α₃=(70400×0.25/0.11)×exp(−2.855×R)

Where the plate thickness of the glass is D (mm) when the external transmittance of the glass with respect to the light with a wavelength of 633 nm is 50%, in one embodiment, d can be equal to D in formula 7 above. In this case, α₃ is calculated by the following formula.

α₃=(70400×0.25/D)×exp(−2.855×R)

For glasses 1 to 6, the lower limit of the CuO content can also be a value defined by the following formula 8 according to the CuO content ratio per molar volume of the glass.

C−3200×0.25/d×exp(−2.855×R)≥0 (Formula 8)

In formula 8, d can take a value greater than 0 and 0.25 or less. For example, d is 0.25, 0.24, 0.23, 0.22, 0.21, 0.20, 0.19, 0.18, 0.17, 0.16, 0.15, 0.14, 0.13, 0.12, 0.11, 0.10, 0.09, 0.08, 0.07, 0.06, 0.05, 0.04, 0.03, 0.02, 0.01, and the like. However, the value of d is not limited to these. Small values of d tend to be preferred in order to achieve the desired transmittance half value at a smaller thickness.

For example, when d=0.11, formula 8 is the following formula.

C−3300×0.25/0.11×exp(−2.855×R)≥0

Where the plate thickness of the glass is D (mm) when the external transmittance of the glass with respect to the light with a wavelength of 633 nm is 50%, in one embodiment, d can be equal to D in formula 8 above.

Regarding the CuO content, glasses 1 to 6 can each also fulfill one or more provisions of the formulas for the other glasses.

Glasses 1 to 6 contain P ions as essential cations. As described above, from the viewpoint of improving both the transmittance in the visible region and the near-infrared cutting ability, it is preferable that the O/P ratio be low. In order to lower the O/P ratio, it is preferable to increase the P₂O₅ content. From this point of view, the P₂O₅ content in the glass composition (expressed in mol %) based on oxides can be 33.0% or more, 34.0% or more, 35.0% or more, 36.0% or more, 37.0% or more, 38.0% or more, 39.0% or more, 40.0% or more, 40.5% or more, 41.0% or more, 41.5% or more, 42.0% or more, 42.5% or more, 43.0% or more, 43.5% or more, 44.0% or more, 44.5% or more, 45.0% or more, 45.5% or more, 46.0% or more, 46.5% or more, 47.0% or more, 47.5% or more, 48.0% or more, 48.5% or more, 49.0% or more, 49.5% or more, or 50.0% or more. Since P₂O₅ itself is a component that does not have the near-infrared absorption ability, from the viewpoint of increasing the CuO content that has the near-infrared absorption ability, the P₂O₅ content can be 72.0% or less, 71.0% or less, 70.0% or less, 69.5% or less, 69.0% or less, 68.5% or less, 68.0% or less, 67.5% or less, 67.0% or less, 66.5% or less, 66.0% or less, 65.5% or less, 65.0% or less, 64.5% or less, 64.0% or less, 63.5% or less, 63.0% or less, 62.5% or less, 62.0% or less, 61.5% or less, 61.0% or less, 60.5% or less, or 60.0% or less. Further, from the viewpoint of further suppressing the decrease in weather resistance and/or from the viewpoint of suppressing the deterioration of meltability, it is preferable that the P₂O₅ content be equal to or less than the above value.

For glasses 1 to 6, it is desirable that the glass composition based on oxides be mainly composed of P₂O₅, BaO and CuO in order to obtain the desired transmittance characteristics. From this point of view, the total content of P₂O₅, BaO and CuO (P₂O₅+BaO+CuO) can be 70.0% or more, 75.0% or more, 80.0% or more, or 85.0% or more. Glasses 1 to 6 include P ions, Ba ions and Cu ions as essential cations, and further include one or more kinds of cations selected from the group of main cations in order to obtain thermal stability and/or chemical durability of the glass. Therefore, the total content (P₂O₅+BaO+CuO) is less than 100%, can be 99.0% or less, 98.0% or less, 97.0% or less, 96.0% or less, 95.0% or less, 94.0% or less, 93.0% or less, 92.0% or less, or 91.0% or less.

In one embodiment, in order for the wavelength λ_{T}50, at which the external transmittance including the reflection loss is 50%, to be in the range of 600 nm to 650 nm as a transmittance characteristic in terms of a thickness of 0.16 mm, in the glass composition (expressed in mol %) based on oxides, the total content of P₂O₅, BaO and CuO (P₂O₅+BaO+CuO) can be 84.0% or more, 85.0% or more, 86.0% or more, 87.0% or more, 88.0% or more, 89.0% or more, or 90.0% or more.

In order for the wavelength λ_{T}50, at which the external transmittance including the reflection loss is 50%, to be in the range of 600 nm to 650 nm as a transmittance characteristic in terms of a thickness of 0.21 mm, in the glass composition (expressed in mol %) based on oxides, the total content of P₂O₅, BaO and CuO (P₂O₅+BaO+CuO) can be 80.0% or more, 81.0% or more, 82.0% or more, 83.0% or more, 84.0% or more, 85.0% or more, 86.0% or more, 87.0% or more, 88.0% % or more, 89.0% or more, or 90.0% or more.

In order for the wavelength λ_{T}50, at which the external transmittance including the reflection loss is 50%, to be in the range of 600 nm to 650 nm as a transmittance characteristic in terms of a thickness of 0.25 mm, in the glass composition (expressed in mol %) based on oxides, the total content of P₂O₅, BaO and CuO (P₂O₅+BaO+CuO) can be 75.0% or more, 76.0% or more, 77.0% or more, 78.0% or more, 79.0% or more, 80.0% or more, 81.0% or more, 82.0% or more, 83.0% or more, 84.0% or more, 85.0% or more, 86.0% or more, 87.0% or more, 88.0% or more, 89.0% or more, or 90.0% or more.

In order for the glass thickness at which the wavelength λ_{T}50, at which the external transmittance including the reflection loss at a wavelength of 550 nm or more is 50%, becomes 645 nm to be 0.25 mm or less, in the glass composition (expressed in mol %) based on oxides, the total content of P₂O₅, BaO and CuO (P₂O₅+BaO+CuO) can also can be 80.0% or more, 81.0% or more, 82.0% or more, 83.0% or more, 84.0% or more, 85.0% or more, 86.0% or more, 87.0% or more, 88.0% or more, 89.0% or more, or 90.0% or more.

In order for the glass thickness at which the wavelength λ_{T}50, at which the external transmittance including the reflection loss at a wavelength of 550 nm or more is 50%, becomes 633 nm to be 0.25 mm or less, in the glass composition (expressed in mol %) based on oxides, the total content of P₂O₅, BaO and CuO (P₂O₅+BaO+CuO) can be 81.0% or more, 82.0% or more, 83.0% or more, 84.0% or more, 85.0% or more, 86.0% or more, 87.0% or more, 88.0% or more, 89.0% or more, or 90.0% or more.

Meanwhile, as another embodiment, for the glass in which the molar ratio of the total content (MgO+CaO+SrO+BaO+ZnO) of MgO, CaO, SrO, BaO and ZnO to the total content (Li₂O+Na₂O+K₂O) of Li₂O, Na₂O and K₂O ((MgO+CaO+SrO+BaO+ZnO)/(Li₂O+Na₂O+K₂O)) is 2.0 or more, in order for the wavelength λ_{T}50, at which the external transmittance including the reflection loss is 50%, to be in the range of 600 nm to 650 nm as a transmittance characteristic in terms of a thickness of 0.16 mm, in the glass composition (expressed in mol %) based on oxides, the total content of P₂O₅, BaO and of CuO (P₂O₅+BaO+CuO) can be 65.0% or more, 66.0% or more, 67.0% or more, 68.0% or more, 69.0% or more, or 70.0% or more.

In the another embodiment described above, in order for the wavelength λ_{T}50, at which the external transmittance including the reflection loss is 50%, to be in the range of 600 nm to 650 nm as a transmittance characteristic in terms of a thickness of 0.21 mm, in the glass composition (expressed in mol %) based on oxides, the total content of P₂O₅, BaO and of CuO (P₂O₅+BaO+CuO) can be 60.0% or more, 61.0% or more, 62.0% or more, 63.0% or more, 64.0% or more, or 65.0% or more.

In the another embodiment described above, in order for the wavelength λ_{T}50, at which the external transmittance including the reflection loss is 50%, to be in the range of 600 nm to 650 nm as a transmittance characteristic in terms of a thickness of 0.25 mm, in the glass composition (expressed in mol %) based on oxides, the total content of P₂O₅, BaO and of CuO (P₂O₅+BaO+CuO) can be 55.0% or more, 56.0% or more, 57.0% or more, 58.0% or more, 59.0% or more, or 60.0% or more.

In the another embodiment described above, in order for the glass thickness at which the wavelength λ_{T}50, at which the external transmittance including the reflection loss at a wavelength of 550 nm or more is 50%, becomes 645 nm to be 0.25 mm or less, in the glass composition (expressed in mol %) based on oxides, the total content of P₂O₅, BaO and of CuO (P₂O₅+BaO+CuO) can be 60.0% or more, 61.0% or more, 62.0% or more, 63.0% or more, 64.0% or more, or 65.0% or more.

In the another embodiment described above, in order for the glass thickness at which the wavelength λ_{T}50, at which the external transmittance including the reflection loss at a wavelength of 550 nm or more is 50%, becomes 633 nm to be 0.25 mm or less, in the glass composition (expressed in mol %) based on oxides, the total content of P₂O₅, BaO and of CuO (P₂O₅+BaO+CuO) can be 61.0% or more, 62.0% or more, 63.0% or more, 64.0% or more, 65.0% or more, or 66.0% or more.

In one embodiment, from the viewpoint of increasing the near-infrared cutting ability of the glass and improving the transmittance in the visible region, glasses 1 to 6 can be glasses including B ions and/or Si ions, which tend to shift the half value to the short wavelength side, and in another embodiment, can be glasses including neither B ions nor Si ions.

In glasses 1 to 6, from the viewpoint of further improving the transmittance in the visible region, in the glass composition (expressed in mol %) based on oxides, the total content of B₂O₃ and SiO₂ (B₂O₃+SiO₂) can be 3.0% or less, 2.5% or less, 2.0% or less, 1.5% or less, 1.0% or less, or 0.5% or less.

In glasses 1 to 6, the total content of B₂O₃ and SiO₂ (B₂O₃+SiO₂) can be 0%, 0% or more, or more than 0%.

In glasses 1 to 6, from the viewpoint of further improving the transmittance in the visible region, the content of B₂O₃ can be 3.0% or less, 2.5% or less, 2.0% or less, 1.5% or less, 1.0% or less, or 0.5% or less. The B₂O₃ content ratio can also be 0%.

Meanwhile, for glasses 1 to 6, when the glass is roughly melted in a quartz crucible in order to promote the homogenization of the glass, the SiO₂ content can be more than 0%, 0.01% or more, 0.02% or more, 0.03% or more, 0.04% or more, 0.05% or more, 0.1% or more, 0.2% or more, or 0.3% or more. However, the introduction of excess SiO₂ into the glass tends to degrade the optical homogeneity of the glass. From this point of view, in glasses 1 to 6, the SiO₂ content can be 2.0% or less, 1.4% or less, 0.9% or less, 0.8% or less, 0.6% or less, or 0.4% or less.

Glasses 1 to 6 contain Li ions in one embodiment and do not contain Li ions in another embodiment. Li₂O has a strong ability to maintain the absorption by CuO in the long wavelength region and has a small adverse effect on weather resistance as compared with various glass components. From this point of view, the Li₂O content can be 0% or more, more than 0%, 0.1% or more, 0.5% or more, 1.0% or more, or 1.2% or more. Meanwhile, from the viewpoint of ensuring the thermal stability of the glass and/or further suppressing the decrease in weather resistance, the Li₂O content can be 13.0% or less, 12.0% or less, 11.0% or less, 10.0% or less, 9.0% or less, 8.0% or less, 7.0% or less, 6.0% or less, 5.0% or less, 4.0% or less, 3.0% or less or 2.8% or less. The Li₂O content can be 7.0% or less from the viewpoint of suppressing the deliquescence of the glass.

In glasses 1 to 6, from the viewpoint of improving the meltability, improving the transmittance in the visible region, and improving the near-infrared absorption characteristics, the total content of MgO and Al₂O₃ (MgO+Al₂O₃) is 8.0% or less, can be 7.5% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.8% or less, 1.6% or less, 1.5% or less, or 1.4% or less, and can also be 0%. Meanwhile, from the viewpoint of increasing the weather resistance of the glass and improving the mechanical strength of the glass, the total content of MgO and Al₂O₃ (MgO+Al₂O₃) can be more than 0%, 0.1% or more, 0.2% or more, 0.3% or more, 0.4% or more, 0.5% or more, 0.6% or more, 0.7% or more, 0.8% or more, 0.9% % or more, 1.0% or more, 1.1% or more, or 1.3% or more.

In glasses 1 to 6, Al₂O₃ is a component that can particularly contribute to increasing the weather resistance. The Al₂O₃ content can be 0%, 0% or more, or more than 0%, and from the viewpoint of improving the weather resistance, the content can be 0.1% or more, 0.2% or more, 0.3% or more, 0.4% or more, 0.5% or more, 0.6% or more, 0.7% or more, 0.9% or more, 1.1% or more, or 1.2% or more. Meanwhile, from the viewpoint of further suppressing the decrease in the transmittance in the visible region, the Al₂O₃ content can be 6.0% or less, 5.5% or less, 5.0% or less, or 4.5% or less, 4.0% or less, 3.5% or less, 3.0% or less, or 2.8% or less. In one embodiment, the improvement of the near-infrared absorption characteristics is prioritized over the maintenance of weather resistance of the glass, and from the viewpoint of further increasing the transmittance in the visible region by suppressing the shift of the absorption by CuO to the short wavelength side and improving the near-infrared absorption characteristic, the Al₂O₃ content can be less than 2.0%, 1.9% or less, 1.8% or less, 1.7% or less, 1.6% or less, 1.5% or less, 1.4% or less, 1.3% or less, 1.2% or less, 1.1% or less, 1.0% or less, 0.9% or less, 0.8% or less, 0.7% or less, 0.6% or less and 0.5% or less.

In glasses 1 to 6, MgO is a component that can be added, as appropriate, for the reason of adjusting the thermal stability of the glass, but since this component shifts the absorption by CuO to the short wavelength side and degrades the near-infrared absorption characteristic, the CuO content tends to be difficult to increase. Also, the meltability of the glass tends to decrease as the MgO content increases. From these viewpoints, the MgO content can be 9.0% or less, 8.0% or less, 7.0% or less, 6.0% or less, 5.0% or less, 4.0% or less, 3.0% or less, or 2.0% or less. The MgO content can also be 0%. In one embodiment, from the viewpoint of improving the mechanical strength of the glass, the MgO content can be more than 0%, 0.5% or more, or 1.0% or more.

La₂O₃ is a component that can contribute to increasing the weather resistance without impairing the near-infrared absorption characteristic of the glass. The La₂O₃ content can be 0.10% or more, 0.15% or more, 0.18% or more, or 0.21% or more. Meanwhile, from the viewpoint of further suppressing the decrease in the transmittance in the visible region, the La₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, or 1.0% or less. The La₂O₃ content can be 0%.

Y₂O₃ is also a component that can contribute to increasing the weather resistance without impairing the near-infrared absorption characteristic of the glass. The Y₂O₃ content can be 0.10% or more, 0.15% or more, 0.20% or more, 0.25% or more, 0.30% or more, 0.35% or more, 0.40% or more, 0.45% or more, or 0.50% or more. Meanwhile, from the viewpoint of further suppressing the decrease in the transmittance in the visible region, the Y₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, or 1.0% or less. The Y₂O₃ content can be 0%. Y₂O₃ can also be introduced from the viewpoint of increasing the molar volume of the glass without increasing the specific gravity of the glass.

Gd₂O₃ is also a component that can contribute to increasing the weather resistance. The Gd₂O₃ content can be 0.10% or more, 0.15% or more, 0.18% or more, or 0.21% or more. Meanwhile, from the viewpoint of further suppressing the decrease in the transmittance in the visible region, the Gd₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, or 1.0% or less. The Gd₂O₃ content can be 0%.

The glass composition based on oxides can contain one or two or more kinds of rare earth oxides other than the above, such as Lu₂O₃ and Sc₂O₃. Alternatively, it is possible for one or two or more kinds of rare earth oxides other than the above not to be contained in the glass composition. Since these components are generally expensive, the content of rare earth oxides (if two or more are included, the total content thereof) other than La₂O₃, Y₂O₃ and Gd₂O₃ can be 2.5% or less, 1.5% or less, 1.0% or less, or 0.5% or less, and can also be 0%.

In glasses 1 to 6, from the viewpoint of improving the weather resistance, the total content of Al₂O₃, La₂O₃, Y₂O₃ and Gd₂O₃ (Al₂O₃+La₂O₃+Y₂O₃+Gd₂O₃) can be 0.1% or more, 0.15% or more, 0.20% or more, 0.25% or more, 0.30% or more, 0.35% or more, 0.40% or more, 0.45% or more, or 0.50% or more. Meanwhile, from the viewpoint of ensuring the thermal stability of the glass and/or lowering the melting temperature, the total content (Al₂O₃+La₂O₃+Y₂O₃+Gd₂O₃) can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, or 1.0% or less.

In glasses 1 to 6, Ba ions are essential cations. The BaO content of glasses 1 to 6 can be more than 0%. BaO is a component that can increase weather resistance when introduced in a certain amount, and tends to cause less deliquescence than alkali metal oxides. Moreover, BaO can be added for the purpose of improving the thermal stability and adjusting the meltability of the glass. Furthermore, BaO can contribute to lowering T1200, but excessive introduction tends to lower T400. T1200 and T400 will be described hereinbelow. From the above viewpoints, in glasses 1 to 6, the BaO content can be 10.0% or more, or 11.0% or more. In view of the above, in glasses 1 to 6, the BaO content can be 23.0% or less, or 22.0% or less.

The SrO content can be 0%, 0% or more, or more than 0%. Like BaO, SrO is a component that is relatively unlikely to cause decrease in weather resistance, and can be added, as appropriate, for the reasons such as adjusting the thermal stability of the glass. SrO can also be used to adjust the concentration of CuO. The SrO content can be 0.5% or more, 1.0% or more, 1.5% or more, 2.0% or more, 2.5% or more, 3.0% or more, 3.5% or more, 4.0% or more, 4.5% or more, 5.0% or more, 5.5% or more, 6.0% or more, 6.5% or more, or 7.0% or more. However, since the excessive introduction tends to decrease T400, the SrO content can be 30.0% or less, 29.0% or less, 28.0% or less, 27.0% or less, 26.0% or less, 25.0% or less, 24.0% or less, 23.0% or less, 22.0% or less, 21.0% or less, 20.0% or less, 19.0% % or less, 18.0% or less, 17.0% or less, 16.0% or less, 15.0% or less, 14.0% or less, 13.0% or less, 12.0% or less, 11.0% or less, 10.0% or less, or 9.0% or less.

The CaO content can be 0%, 0% or more, or more than 0%. CaO is a component that is relatively unlikely to cause decrease in weather resistance, and can be added, as appropriate, for the reasons such as adjusting the thermal stability of the glass. CaO can also be used to adjust the concentration of CuO. The CaO content can be 0.5% or more, 1.0% or more, 1.5% or more, 2.0% or more, 2.5% or more, 3.0% or more, 3.5% or more, 4.0% or more, 4.5% or more, 5.0% or more, 5.5% or more, 6.0% or more, 6.5% or more, or 7.0% or more. However, since the excessive introduction tends to decrease T400, the CaO content can be 30.0% or less, 29.0% or less, 28.0% or less, 27.0% or less, 26.0% or less, 25.0% or less, 24.0% or less, 23.0% or less, 22.0% or less, 21.0% or less, 20.0% or less, 19.0% or less, 18.0% or less, 17.0% or less, 16.0% or less, 15.0% or less, 14.0% or less, 13.0% or less, 12.0% or less, 11.0% or less, 10.0% or less, or 9.0% or less.

The Na₂O content can be 0%, 0% or more, or more than 0%. Excessive introduction of Na₂O tends to decrease the weather resistance. Therefore, the Na₂O content can be 5.0% or less, 4.0% or less, 3.0% or less, 2.0% or less, or 1.0% or less.

The K₂O content can be 0%, 0% or more, or more than 0%. Among alkali metal oxides, K₂O has the effect of further improving the near-infrared absorption characteristic as compared to Li₂O and Na₂O. Meanwhile, the excessive introduction of K₂O tends to decrease the weather resistance. From these viewpoints, the K₂O content can be 10.0% or less, 9.0% or less, 8.0% or less, 7.0% or less, 6.0% or less, 5.0% or less, 4.0% or less, 3.0% or less, 2.0% or less, or 1.0% or less.

The Cs₂O content can be 0%, 0% or more, or more than 0%. Since Cs₂O also tends to decrease the weather resistance, it is desirable not to actively introduce it. The Cs₂O content can be 15.0% or less, 14.0% or less, 13.0% or less, 12.0% or less, 11.0% or less, 10.0% or less, 9.0% or less, 8.0% or less, 7.0% or less, or 6.0% or less. Meanwhile, in order to adjust the thermal stability and meltability, the Cs₂O content can be 0.5% or more, and also can be 1.0% or more, 1.5% or more, 2.0% or more, 2.5% or more, 3.0% or more, 3.5% or more, or 4.0% or more.

The total content of Li₂O, Na₂O and K₂O (Li₂O+Na₂O+K₂O) can be 0%, 0% or more, or more than 0%. From the viewpoint of further suppressing the decrease in weather resistance, the total content (Li₂O+Na₂O+K₂O) can be 15.0% or less, 14.0% or less, 13.0% or less, 12.0% or less, 11.0% or less, or 10.0% or less. The total content (Li₂O+Na₂O+K₂O) can be equal to or less than the above values from the viewpoint of avoiding chipping and cracking of the glass that occur because the amount of expansion and contraction of the glass increases due to the increase in the coefficient of thermal expansion, and a stress is applied to the glass when the volume change of the glass is regulated by other members.

From the viewpoint of suppressing the deliquescence of the glass, the total content of Na₂O and K₂O (Na₂O+K₂O) can be 15.0% or less, 14.0% or less, 13.0% or less, 12.0% or less, 11.0% or less, 10.0% or less, or 9.0% or less. The total content of Na₂O and K₂O (Na₂O+K₂O) can be 0%, 0% or more, or more than 0%. By setting the total content of Na₂O and K₂O (Na₂O+K₂O) to 0%, it is possible to obtain a glass in which the deliquescence is further suppressed. Meanwhile, from the viewpoint of suppressing the raw material cost of the glass while suppressing the meltability of the glass and suppressing the decrease in T600, the total content (Na₂O+K₂O) can be 1.0% or more, and also can be 2.0% or more, 3.0% or more, 4.0% or more, 5.0% or more, 6.0% or more, 7.0% or more, 8.0% or more, 9.0% or more, 10.0% % or more, 11.0% or more, 12.0% or more, 13.0% or more, 14.0% or more, or 15.0% or more.

As for the weather resistance, the suppression of deliquescence of the glass and/or the suppression of the occurrence of precipitates on the glass surface under high temperature and high humidity conditions can be used as indicators of weather resistance. This point will be further described hereinbelow. In order to further improve the weather resistance, one or more of Al₂O₃, Y₂O₃, La₂O₃ and Gd₂O₃ can be introduced. In addition, BaO can improve the weather resistance described above when introduced in a relatively large amount, and SrO and CaO need to be introduced in a larger amount from the viewpoint of improving the weather resistance. For these reasons, a value calculated as “(3×Al₂O₃+Y₂O₃+La₂O₃+Gd₂O₃+BaO/3+(CaO+SrO)/6)” (unit: mol %) can be 0% or more, more than 0%, 0.5% or more, 1.0% or more, 2.0% or more, 3.0% or more, 4.0% or more, 5.0% or more, 6.0% or more, 7.0% or more, or 8.0% or more. Furthermore, when the weather resistance and mechanical strength of the glass are emphasized, this value can be 9.0% or more, 10.0% or more, 11.0% or more, 12.0% or more, 13.0% or more, 14.0% or more, 15.0% or more, 16.0% or more, 17.0% or more, 18.0% or more, or 19.0% or more. In “(3×Al₂O₃+Y₂O₃+La₂O₃+Gd₂O₃+BaO/3+(CaO+SrO)/6)”, “Al₂O₃” is the Al₂O₃ content, “Y₂O₃” is the Y₂O₃ content, “La₂O₃” is the La₂O₃ content, “Gd₂O₃” is the Gd₂O₃ content, “BaO” is the BaO content, “CaO” is the CaO content, and “SrO” is the SrO content. That is, “(3×Al₂O₃+Y₂O₃+La₂O₃+Gd₂O₃+BaO/3+(CaO+SrO)/6)” is a sum of a value calculated by multiplying the Al₂O₃ content by 3, the Y₂O₃ content, the La₂O₃ content, the Gd₂O₃ content, a value obtained by dividing the BaO content by 3, and a value calculated as ⅙ of the total of the CaO content and the SrO content, and the value thus calculated is expressed by adding % (mol %) as a unit.

Meanwhile, where the value of “(3×Al₂O₃+Y₂O₃+La₂O₃+Gd₂O₃+BaO/3+(CaO+SrO)/6)” is too large, the meltability of the glass tends to deteriorate, and the near-infrared absorption position tends to shift to the visible light side. Therefore, due to the above reasons and the like, the value calculated as “(3×Al₂O₃+Y₂O₃+La₂O₃+Gd₂O₃+BaO/3+(CaO+SrO)/6)” can be 40.0% or less, 37.0% or less, 35.0% or less, 33.0% or less, 32.0% or less, 30.0% or less, 28.0% or less, 26.0% or less, 25.0% or less, 24.0% or less, 23.0% or less, 22.0% or less, or 21.0% or less.

The ratio of the value calculated by “(3×Al₂O₃+Y₂O₃+La₂O₃+Gd₂O₃+BaO/3+(CaO+SrO)/6)” to the total content of P₂O₅, BaO and CuO, that is, “(3×Al₂O₃+Y₂O₃+La₂O₃+Gd₂O₃+BaO/3+(CaO+SrO)/6)/(P₂O₅+BaO+CuO)” can be 0.0 or more. A component selected from the group consisting of Al₂O₃, Y₂O₃, La₂O₃, Gd₂O₃, BaO, CaO and SrO is desirably introduced in a certain amount or more relative to P₂O₅, BaO and CuO, which are the essential components. Therefore, the above ratio can be 0.05 or more, 0.06 or more, 0.07 or more, 0.08 or more, 0.09 or more, 0.10 or more, or 0.11 or more.

Meanwhile, where the above ratio is too large, the transmittance characteristics of the glass deteriorate and tendency for decrease in stability of the glass is also intensified. Therefore, the above ratio can be 0.32 or less, 0.30 or less, 0.28 or less, 0.26 or less, 0.24 or less, 0.22 or less, 0.20 or less, or 0.18 or less.

The ZnO content can be 0%, 0% or more, or more than 0%. ZnO is a component that can be added as appropriate for reasons such as adjusting the thermal stability of the glass, but this component can deteriorate the near-infrared absorption characteristic as compared to other divalent components (among them, BaO, SrO, and CaO). In addition, from the viewpoint of sufficiently ensuring the introduction amount of P₂O₅, which is an essential component, the upper limit of the content of ZnO can be 10.0% or less, 9.0% or less, 8.0% or less, 7.0% or less, 6.0% or less, or 5.0% or less. Meanwhile, when ZnO is introduced to adjust the thermal stability of the glass and lower Tg and/or Tm, the content thereof can be 0.4% or more, 0.6% or more, 0.8% or more, 1.0% or more, 1.2% or more, 1.4% or more, 1.6% or more, 1.8% or more, or 2.0% or more.

Glasses 1 to 6 can be basically composed of the above components, but other components can be contained within the ranges that do not impede the effects of the above components. In addition, the inclusion of unavoidable impurities in glasses 1 to 6 is not excluded.

For example, Nb₂O₅ and ZrO₂ can be introduced, as appropriate, each in an amount of more than 0%, 0.1% or more, or 0.2% or more as components other than the above components to adjust the weather resistance and mechanical strength of the glass, or to improve the thermal stability, but the content of each of these components can be 5.0% or less, 4.0% or less, 3.0% or less, 2.0% or less, 1.0% or less, 0.5% or less, or 0.3% or less. The content of each of these components can also be 0%.

TiO₂, WO₃, and Bi₂O₃ can also be introduced, as appropriate, each in an amount of more than 0%, 0.1% or more, or 0.2% or more, to the extent that the transmittance of the glass is not adversely affected, as components other than the above components to adjust the weather resistance and mechanical strength of the glass, or to improve the thermal stability, but the content of each of these components can be 4.0% or less, 3.0% or less, 2.0% or less, 1.0% or less, 0.5% or less, or 0.3% or less. The content of each of these components can also be 0%.

All of Pb, As, Cd, TI, Be, and Se are toxic. Therefore, glasses 1 to 6 can contain none of these as glass components.

All of U, Th, and Ra are radioactive elements. Therefore, glasses 1 to 6 an contain none of these as glass components.

V, Cr, Mn, Fe, Co, Ni, Pr, Nd, Pm, Sm, Eu, Tb, Dy, Ho, Er, and Tm can increase the coloration of glass and become a source of fluorescence. Therefore, in glasses 1 to 6, the total content of these elements in terms of oxides based on oxide glass can be 10 ppm by mass or less, and it is possible not to include these elements as glass components.

Among them, it is possible not to use V₂O₅ because it is toxic and deteriorates the transmittance characteristics in the visible range. That is, in one embodiment, glasses 1 to 6 can be glasses that do not contain V ions, and the V₂O₅ content in the glass composition (expressed in mol %) based on oxides can be 1.0% or less, 0.3% or less, 0.1% or less, or 0.01% or less, and it is possible not to include V₂O₅.

As an example, as a ratio of V₂O₅ and Li₂O, which is an essential component, the ratio of the V₂O₅ content to the Li₂O content (V₂O₅/Li₂O) can be 0.0080 or less, 0.0048 or less, 0.0028 or less, 0.0018 or less or 0.0014 or less.

CoO reduces the transmittance of the glass in the visible range and is also toxic, so it is preferable not to use it. That is, in one embodiment, glasses 1 to 6 can be glasses that do not contain Co ions, and can be glasses that do not contain CoO in the glass composition based on oxides.

The raw materials for introducing Ge and Ta into glass are expensive. Therefore, glasses 1 to 6 can contain none of these as glass components.

Sb (Sb₂O₃), Sn (SnO₂), Ce (CeO₂), and SO₃ are optionally added elements that function as clarifying agents. Among these, Sb (Sb₂O₃) is a clarifying agent having a large clarifying effect.

Sn (SnO₂) and Ce (CeO₂) have a smaller clarifying effect than Sb (Sb₂O₃).

These clarifying agents tend to increase the coloration of the glass when added in large amounts. Therefore, when adding a clarifying agent, it is possible to add Sb (Sb₂O₃) while considering the influence of coloration due to the addition.

For the content of components that can function as clarifying agents described below, the value in the glass composition based on oxides is shown.

The Sb₂O₃ content is expressed as external percentage. That is, when the total content of all glass components as oxides other than Sb₂O₃, SnO₂, CeO₂ and SO₃ is taken as 100.0% by mass, the Sb₂O₃ content can be less than 2.0% by mass, 1.5% by mass or less, 1.2% by mass or less, 1.0% by mass or less, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or less than 0.1% by mass. The content of Sb₂O₃ can be 0% by mass. However, from the viewpoint of promoting the oxidation of the glass and increasing the transmittance in the visible range, the Sb₂O₃ content can be 0.01% by mass or more and also can be 0.02% by mass or more, 0.03% by mass or more, and 0.04% by mass or more, 0.05% by mass or more, 0.06% by mass or more, or 0.08% by mass or more.

The SnO₂ content is also expressed as external percentage. That is, when the total content of all glass components as oxides other than SnO₂, Sb₂O₃, CeO₂ and SO₃ is taken as 100.0% by mass, the content of SnO₂ can be less than 2.0% by mass, less than 1.0% by mass, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or 0.1% by mass or less. The content of SnO₂ can be 0% by mass. By setting the SnO₂ content within the above ranges, the clarity of the glass can be improved.

The CeO₂ content is also expressed as external percentage. That is, when the total content of all glass components as oxides other than CeO₂, Sb₂O₃, SnO₂, and SO₃ is taken as 100.0% by mass, the CeO₂ content can be less than 2.0% by mass, less than 1.0% by mass, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or less than 0.1% by mass. The CeO₂ content can be 0% by weight. By setting the CeO₂ content within the above ranges, the clarity of the glass can be improved.

The SO₃ content is also expressed as external percentage. That is, when the total content of all glass components as oxides other than SO₃, Sb₂O₃, SnO₂, and CeO₂ is taken as 100.0% by mass, the SO₃ content can be less than 2.0% by mass, less than 1.0% by mass, less than 0.5% by mass, or within the range of less than 0.1% by mass. The SO₃ content can be 0% by mass. By setting the content of SO₃ within the above range, the clarity of the glass can be improved.

In one embodiment, glasses 1 to 6 have a ratio of the BaO content to the Li₂O content (BaO/Li₂O) of 1.0 or more in the glass composition expressed in mol % based on oxides, and one or more of the following (1) to (4) can be satisfied. Glasses 1 to 6 can satisfy only one, can satisfy two or more, can satisfy three or more, and can satisfy four of the following (1) to (4).
(1) The ratio of the total content of CaO, SrO and ZnO to the BaO content ((CaO+SrO+ZnO)/BaO) is 0.02 or more,
(2) the ratio of the total content of CaO, SrO and ZnO to the total content of MgO and BaO ((CaO+SrO+ZnO)/(MgO+BaO)) is 0.02 or more,
(3) the ratio of the total content of K₂O+CaO+SrO to the BaO content ((K₂O+CaO+SrO)/BaO) is 0.12 or more, and
(4) the ratio of the total content of K₂O, CaO, SrO and ZnO to the total content of MgO and BaO ((K₂O+CaO+SrO+ZnO)/(MgO+BaO)) is 0.12 or more.

<Glass 7>

Next, glass 7 will be explained.

Glass 7 is a near-infrared absorbing glass having the following glass composition expressed in mol % based on oxides,
the P₂O₅ content is 40.0 mol % to 65.0 mol %,
the CuO content is 9.0 mol % to 25.0 mol %,
the BaO content is 5.0 mol % to 50.0 mol %,
the total content of Li₂O, Na₂O and K₂O (Li₂O+Na₂O+K₂O) is 1.0 mol % to 15.0 mol %,
the SiO₂ content is 2.0 mol % or less,
the B₂O₃ content is 2.0 mol % or less,
the Al₂O₃ content is 0.5 mol % or more and 7.0 mol % or less,
the Li₂O content is 7.0 mol % or less,
the ZnO content of 10.0 mol % or less,
the PbO content is 2.0 mol % or less,
the ratio of the MgO content to the total content of MgO, CaO, SrO and BaO (MgO/(MgO+CaO+SrO+BaO)) is 0.3 or less,
in a glass composition expressed in atomic %, the ratio of the content of 0 ions to the content of P ions (O ions/P ions) is 3.50 or less, and
in a glass composition expressed in atomic %, the content of F ions is 10.0 anion % or less.

In glass 7, the P₂O₅ content, the CuO content, the BaO content, the total content of Li₂O, Na₂O and K₂O, the SiO₂ content, the B₂O₃ content, the Al₂O₃ content, the Li₂O content, the ZnO content, the PbO content and the ratio of the MgO content to the total content of MgO, CaO, SrO and BaO are within the above ranges. In such glass 7, from the viewpoint of improving both the transmittance in the visible region and the near-infrared cutting ability and also from the viewpoint of improving the thermal stability of the glass, the ratio of the content of O ions to the content of P ions (O/P ratio) in the glass composition expressed in atomic % is 3.50 or less. In glass 7, the O/P ratio can be 3.40 or less, 3.30 or less, or 3.20 or less.

From the viewpoint of providing glass 7 with a transmittance characteristic in which the external transmittance at a wavelength of 400 nm is 75% or more and the external transmittance at a wavelength of 1200 nm is 7% or less at a thickness of 0.25 mm or less in terms of a thickness at which the external transmittance is 50% at a wavelength of 620 to 650 nm, the O/P ratio can be 3.15 or less, 3.10 or less, or 3.05 or less. Meanwhile, from the viewpoint of improving the weather resistance and/or suppressing the deterioration of the meltability, the O/P ratio in glass 7 can be large. From this point of view, the O/P ratio in glass 7 can be 2.85 or more, 2.86 or more, 2.87 or more, 2.88 or more, 2.89 or more, 2.90 or more, or 3.00 or more.

The glass composition (expressed in mol %) based on oxides of glass 7 will be described in more detail below.

The CuO content of glass 7 is 9.0% or more, can be 9.5% or more, 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more. From the viewpoint of leaving room for introducing glass-forming components and maintaining the thermal stability of the glass, the CuO content can be 25.0% or less, 24.5% or less, 24.0% or less, 23.5% or less, 23.0% or less, 22.5% or less, 22.0% or less, 21.5% or less, 21.0% or less, or 20.5% or less.

In order for the wavelength λ_{T}50, at which the external transmittance including the reflection loss is 50%, to be in the range of 600 nm to 650 nm as a transmittance characteristic in terms of a thickness of 0.16 mm, the CuO content can be 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the wavelength λ_{T}50, at which the external transmittance including the reflection loss is 50%, to be in the range of 600 nm to 650 nm as a transmittance characteristic in terms of a thickness of 0.21 mm, the CuO content can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the wavelength λ_{T}50, at which the external transmittance including the reflection loss is 50%, to be in the range of 600 nm to 650 nm as a transmittance characteristic in terms of a thickness of 0.25 mm, the CuO content can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

Meanwhile, regarding the transmittance characteristics in terms of the thickness of 0.25 mm, where the CuO content is large, the wavelength λ_{T}50, at which the external transmittance including the reflection loss is 50%, can be less than 600 nm. Therefore, the CuO content can be 25.0% or less, 24.5% or less, 24.0% or less, 23.5% or less, 23.0% or less, 22.5% or less, 22.0% or less, 21.5% or less, 21.0% or less, 20.5% or less, or 20.0% or less.

In order for the thickness of the glass at which the wavelength λ_{T}50, at which the external transmittance including the reflection loss is 50% at a wavelength of 550 nm or more, is 645 nm to be 0.25 mm or less, the CuO content can be 10.0% or more, 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

In order for the thickness of the glass at which the wavelength λ_{T}50, at which the external transmittance including the reflection loss is 50% at a wavelength of 550 nm or more, is 633 nm to be 0.25 mm or less, the CuO content can be 10.5% or more, 11.0% or more, 11.5% or more, 12.0% or more, 12.5% or more, 13.0% or more, 13.5% or more, 14.0% or more, 14.5% or more, 15.0% or more, 15.5% or more, 16.0% or more, 16.5% or more, 17.0% or more, 17.5% or more, 18.0% or more, 18.5% or more, 19.0% or more, 19.5% or more, or 20.0% or more.

Glass 7 contains P₂O₅ as an essential component. As described above, from the viewpoint of improving both the transmittance in the visible region and the near-infrared cutting ability, the O/P ratio can be low. In order to lower the O/P ratio, the P₂O₅ content can be increased. From this point of view, the P₂O₅ content of glass 7 is 40.0% or more, can be 41.0% or more, 42.0% or more, 43.0% or more, 44.0% or more, 45.0% or more, 46.0% or more, 47.0% or more, 48% or more, 49.0% or more, 50% or more, 51.0% or more, or 52.0% or more. Since P₂O₅ itself is a component having no near-infrared absorption ability, from the viewpoint of increasing the CuO content having the near-infrared absorption ability, the P₂O₅ content can be 65.0% or less, 64.0% or less, 63.0% or less, 62.0% or less, 61.0% or less, 60.0% or less, 59.0% or less, 58.0% or less, 57.0% or less, 56.0% or less, 55.0% or less, 54.0% or less, or 53.0% or less. Further, from the viewpoint of further suppressing the decrease in weather resistance and/or from the viewpoint of suppressing the decrease in meltability, the P₂O₅ content can be equal to or less than the above values.

In one embodiment, from the viewpoint of increasing the near-infrared cutting ability of the glass and improving the transmittance in the visible region, glass 7 can also be glass containing B₂O₃ and/or SiO₂, which tend to shift the half value to the short wavelength side, in the glass composition based on oxides, and in another embodiment, can be a glass including neither B₂O₃ nor SiO₂.

From the viewpoint of further improving the transmittance in the visible region in glass 7, the SiO₂ content is 2.0% or less, can be 1.5% or less, 1.0% or less, or 0.5% or less. The B₂O₃ content can also be 0%.

Meanwhile, for glass 7, when the glass is roughly melted in a quartz crucible in order to promote the homogenization of the glass, the SiO₂ content can be more than 0%, 0.01% or more, 0.02% or more, 0.03% or more, 0.04% or more, 0.05% or more, 0.1% or more, 0.2% or more, or 0.3% or more. However, the introduction of excess SiO₂ into the glass tends to degrade the optical homogeneity of the glass. From this point of view, in glass 7, the SiO₂ content can be 2.0% or less, 1.4% or less, 0.9% or less, 0.8% or less, 0.6% or less, or 0.4% or less.

From the viewpoint of further improving the transmittance in the visible region in glass 7, the B₂O₃ content is 2.0% or less, can be 1.5% or less, 1.0% or less, or 0.5% or less. The B₂O₃ content can also be 0%.

Meanwhile, for glass 7, when the glass is roughly melted in a quartz crucible in order to promote the homogenization of the glass, the B₂O₃ content can be more than 0%, 0.01% or more, 0.02% or more, 0.03% or more, 0.04% or more, 0.05% or more, 0.1% or more, 0.2% or more, or 0.3% or more. However, the introduction of excess B₂O₃ into the glass tends to degrade the optical homogeneity of the glass. From this point of view, in glass 7, the B₂O₃ content can be 2.0% or less, 1.4% or less, 0.9% or less, 0.8% or less, 0.6% or less, or 0.4% or less.

Glass 7 contains Li₂O in one embodiment and does not contain Li₂O in another embodiment in the glass composition based on oxides. Li₂O has a strong ability to maintain the absorption by CuO in the long wavelength region and has a small adverse effect on weather resistance as compared with various glass components. From this point of view, the Li₂O content can be 0% or more, more than 0%, 0.1% or more, 0.5% or more, 1.0% or more, or 1.2% or more. Meanwhile, from the viewpoint of ensuring the thermal stability of the glass and/or further suppressing the decrease in weather resistance, the Li₂O content in glass 7 can be 7.0% or less, 6.0% or less, 5.0% or less, 4.0% or less, 3.0% or less, or 2.8% or less. The Li₂O content can be 7.0% or less from the viewpoint of suppressing the deliquescence of the glass.

In Glass 7, Al₂O₃ is a component that can particularly contribute to increasing the weather resistance. From the viewpoint of improving the weather resistance, the Al₂O₃ content is 0.5% or more, can be 0.6% or more, 0.7% or more, 0.9% or more, 1.1% or more, or 1.2% or more. Meanwhile, from the viewpoint of further suppressing the decrease in the transmittance in the visible region and improving the near-infrared absorption characteristics, the Al₂O₃ content is 7.0% or less, can be 6.5% or less, 6.0% or less, 5.5% or less, 5.0% or less, or 4.5% or less, 4.0% or less, 3.5% or less, 3.0% or less, or 2.5% or less.

In glass 7, MgO is a component that can be added, as appropriate, for adjusting the thermal stability of the glass, but since this component shifts the absorption by CuO to the short wavelength side and degrades the near-infrared absorption characteristic, the CuO content tends to be difficult to increase. Also, the meltability of the glass tends to decrease as the MgO content increases. From these viewpoints, the MgO content can be 9.0% or less, 8.0% or less, 7.0% or less, 6.0% or less, 5.0% or less, 4.0% or less, 3.0% or less, or 2.0% or less. The MgO content can also be 0%. In one embodiment, from the viewpoint of improving the mechanical strength of the glass, the MgO content can be more than 0%, 0.5% or more, or 1.0% or more.

La₂O₃ is a component that can contribute to increasing the weather resistance without impairing the near-infrared absorption characteristic of the glass. The La₂O₃ content can be 0.10% or more, 0.15% or more, 0.18% or more, or 0.21% or more. Meanwhile, from the viewpoint of further suppressing the decrease in the transmittance in the visible region, the La₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, 1.0% or less, 0.5% or less, or 0.1% or less. The La₂O₃ content can be 0%.

Y₂O₃ is also a component that can contribute to increasing the weather resistance without impairing the near-infrared absorption characteristic of the glass. The Y₂O₃ content can be 0.10% or more, 0.15% or more, 0.20% or more, 0.25% or more, 0.30% or more, 0.35% or more, 0.40% or more, 0.45% or more, or 0.50% or more. Meanwhile, from the viewpoint of further suppressing the decrease in the transmittance in the visible region, the Y₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, 1.0% or less, 0.5% or less, or 0.1% or less. The Y₂O₃ content can be 0%.

Y₂O₃ can also be introduced from the viewpoint of increasing the molar volume of the glass without increasing the specific gravity of the glass.

Gd₂O₃ is also a component that can contribute to increasing the weather resistance. The Gd₂O₃ content can be 0.10% or more, 0.15% or more, 0.18% or more, or 0.21% or more. Meanwhile, from the viewpoint of further suppressing the decrease in the transmittance in the visible region, the Gd₂O₃ content can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, 1.0% or less, 0.5% or less, or 0.1% or less. The Gd₂O₃ content can be 0%.

It is possible for the glass composition based on oxides to contain or not to contain one or two or more kinds of rare earth oxides other than the above, such as Lu₂O₃ and Sc₂O₃. Since these components are generally expensive, the content of rare earth oxides (if two or more are included, the total content thereof) other than La₂O₃, Y₂O₃ and Gd₂O₃ can be 2.5% or less, 1.5% or less, 1.0%, or 0.5% or less, and 0% is also possible.

In glass 7, from the viewpoint of improving the weather resistance, the total content of Al₂O₃, La₂O₃, Y₂O₃ and Gd₂O₃ (Al₂O₃+La₂O₃+Y₂O₃+Gd₂O₃) can be 0.5% or more, 0.55% or more, 0.60% or more, 0.65% or more, 0.70% or more, 0.75% or more, 0.80% or more, 0.85% or more, or 0.90% or more. Meanwhile, from the viewpoint of ensuring the thermal stability of the glass and/or lowering the melting temperature, the total content (Al₂O₃+La₂O₃+Y₂O₃+Gd₂O₃) can be 8.0% or less, 7.0% or less, 6.5% or less, 6.0% or less, 5.5% or less, 5.0% or less, 4.5% or less, 4.0% or less, 3.5% or less, 3.0% or less, 2.5% or less, 2.0% or less, 1.5% or less, or 1.0% or less.

In the glass composition based on oxides of glass 7, BaO is an essential component. BaO is a component that can increase the weather resistance when introduced in a certain amount, and tends to cause less deliquescence than alkali metal oxides. Moreover, BaO can be added for the purpose of improving the thermal stability and adjusting the meltability of the glass. Furthermore, BaO can contribute to lowering T1200, but the excessive introduction tends to lower T400. T1200 and T400 will be described hereinbelow. From the above viewpoints, the BaO content in glass 7 is 5.0% or more, can be 10.0% or more, 15.0% or more, 17% or more, 19% or more, or 21% or more. From the above viewpoint, the BaO content in glass 7 is 50.0% or less, can be 45.0% or less, 40.0% or less, 35.0% or less, 30.0% or less, 28.0% or less, 26.0% or less, or 24.0% or less.

The SrO content can be 0%, 0% or more, or more than 0%. Like BaO, SrO is a component that is relatively unlikely to cause decrease in weather resistance, and can be added, as appropriate, for adjusting the thermal stability of the glass or the like. SrO can also be used to adjust the concentration of CuO. The SrO content can be 0.5% or more, 1.0% or more, 1.5% or more, 2.0% or more, 2.5% or more, 3.0% or more, 3.5% or more, 4.0% or more, 4.5% or more, 5.0% or more, 5.5% or more, 6.0% or more, 6.5% or more, or 7.0% or more. However, since the excessive introduction tends to decrease T400, the SrO content can be 30.0% or less, 29.0% or less, 28.0% or less, 27.0% or less, 26.0% or less, 25.0% or less, 24.0% or less, 23.0% or less, 22.0% or less, 21.0% or less, 20.0% or less, 19.0% % or less, 18.0% or less, 17.0% or less, 16.0% or less, 15.0% or less, 14.0% or less, 13.0% or less, 12.0% or less, 11.0% or less, 10.0% or less, or 9.0% or less.

The CaO content can be 0%, 0% or more, or more than 0%. CaO is a component that is relatively unlikely to cause decrease in weather resistance, and can be added, as appropriate, for the reasons such as adjusting the thermal stability of the glass. CaO can also be used to adjust the concentration of CuO. The CaO content can be 0.5% or more, 1.0% or more, 1.5% or more, 2.0% or more, 2.5% or more, 3.0% or more, 3.5% or more, 4.0% or more, 4.5% or more, 5.0% or more, 5.5% or more, 6.0% or more, 6.5% or more, or 7.0% or more. However, since the excessive introduction tends to decrease T400, the CaO content can be 30.0% or less, 29.0% or less, 28.0% or less, 27.0% or less, 26.0% or less, 25.0% or less, 24.0% or less, 23.0% or less, 22.0% or less, 21.0% or less, 20.0% or less, 19.0% or less, 18.0% or less, 17.0% or less, 16.0% or less, 15.0% or less, 14.0% or less, 13.0% or less, 12.0% or less, 11.0% or less, 10.0% or less, or 9.0% or less.

The Na₂O content can be 0%, 0% or more, or more than 0%. The excessive introduction of Na₂O tends to decrease the weather resistance. Therefore, the Na₂O content can be 5.0% or less, 4.0% or less, 3.0% or less, 2.0% or less, or 1.0% or less.

The K₂O content can be 0%, 0% or more, or more than 0%. Among the same class of alkalis, K₂O has the effect of improving the near-infrared absorption characteristics compared to Li₂O Na₂O, but also tends to reduce the weather resistance when excessively introduced. From these viewpoints, the K₂O content can be 10.0% or less, 9.0% or less, 8.0% or less, 7.0% or less, 6.0% or less, 5.0% or less, 4.0% or less, 3.0% or less, 2.0% or less, or 1.0% or less.

The Cs₂O content can be 0%, 0% or more, or more than 0%. Since Cs₂O also tends to decrease the weather resistance, it is desirable not to actively introduce it. The Cs₂O content can be 15.0% or less, 14.0% or less, 13.0% or less, 12.0% or less, 11.0% or less, 10.0% or less, 9.0% or less, 8.0% or less, 7.0% or less, or 6.0% or less. Meanwhile, in order to adjust the thermal stability and meltability, the Cs₂O content can be 0.5% or more, and also can be 1.0% or more, 1.5% or more, 2.0% or more, 2.5% or more, 3.0% or more, 3.5% or more, or 4.0% or more.

In glass 7, from the viewpoint of meltability and near-infrared absorption characteristics, the total content of Li₂O, Na₂O and K₂O (Li₂O+Na₂O+K₂O) is 1.0% or more, can be 2.0% or more, or 3.0% or more. From the viewpoint of further suppressing the decrease in weather resistance, the total content (Li₂O+Na₂O+K₂O) is 15.0% or less, can be 14.0% or less, 13.0% or less, 12.0% or less, 11.0% or less, and 10.0% or less, 9% or less, 8% or less, 7% or less, 6% or less, 5% or less, or 4% or less. The total content (Li₂O+Na₂O+K₂O) can be equal to or less than the above values from the viewpoint of avoiding chipping and cracking of the glass that occur because the amount of expansion and contraction of the glass increases due to increase in coefficient of thermal expansion, and a stress is applied to the glass when the volume change of the glass is regulated by other members.

The ZnO content can be 0%, 0% or more, or more than 0%. ZnO is a component that can be added as appropriate for reasons such as adjusting the thermal stability of the glass, but from the viewpoint of sufficiently ensuring the introduction amount of P₂O₅, which is an essential component, the content of ZnO in glass 7 is 10.0% or less, can be 9.0% or less, 8.0% or less, 7.0% or less, 6.0% or less, and 5.0% or less, 4.0% or less, 3.0% or less, or 2.5% or less. Meanwhile, when ZnO is introduced to adjust the thermal stability of the glass and lower Tg and/or Tm, the ZnO content can be 0.4% or more, 0.6% or more, 0.8% or more, 1.0% or more, 1.2% or more, 1.4% or more, 1.6% or more, 1.8% or more, or 2.0% or more.

In glass 7, from the viewpoint of maintaining the near-infrared transmittance absorption characteristics while maintaining the weather resistance, the ratio of the MgO content to the total content of MgO, CaO, SrO and BaO (MgO/(MgO+CaO+SrO+BaO)) is 0.3 or less, can be 0.25 or less, 0.20 or less, 0.15 or less, 0.10 or less, or 0.05 or less, and can also be 0.

Glass 7 can be basically composed of the above components, but other components can be contained within the ranges that do not impede the effects of the above components. In addition, the inclusion of unavoidable impurities is glass 7 is not excluded.

For example, Nb₂O₅ and ZrO₂ can be introduced, as appropriate, each in an amount of more than 0%, 0.1% or more, or 0.2% or more as components other than the above components to adjust the weather resistance and mechanical strength of the glass, or to improve the thermal stability. The content of each of these components can be 5.0% or less, 4.0% or less, 3.0% or less, 2.0% or less, 1.0% or less, 0.5% or less, or 0.3% or less. The content of each of these components can also be 0%.

TiO₂, WO₃, and Bi₂O₃ can also be introduced, as appropriate, each in an amount of more than 0%, 0.1% or more, or 0.2% or more, to the extent that the transmittance of the glass is not adversely affected, as components other than the above components to adjust the weather resistance and mechanical strength of the glass, or to improve the thermal stability, but the content of each of these components can be 4.0% or less, 3.0% or less, 2.0% or less, 1.0% or less, 0.5% or less, or 0.3% or less. The content of each of these components can also be 0%.

In glass 7, the PbO content is 2.0 mol % or less. Since Pb is toxic, the PbO content in glass 7 can be 0%.

All of As, Cd, TI, Be, and Se are toxic. In one embodiment, glass 7 can be a glass that does not contain these as glass components.

All of U, Th, and Ra are radioactive elements. In one embodiment, glass 7 can be a glass that does not contain these as glass components.

V, Cr, Mn, Fe, Co, Ni, Pr, Nd, Pm, Sm, Eu, Tb, Dy, Ho, Er, and Tm can increase the coloration of glass and become a source of fluorescence. Therefore, in glass 7, the total content of these elements in terms of oxides based on oxide glass can be 10 ppm by mass or less. In one embodiment, glass 7 does not include these elements as glass components.

Among them, it is possible not to use V₂O₅ because it is toxic and deteriorates the transmittance characteristics in the visible range. That is, in one embodiment, glass 7 can be a glass that does not contain V₂O₅, and the V₂O₅ content in the glass composition (expressed in mol %) based on oxides can be 1.0% or less, 0.3% or less, 0.1% or less, or 0.01% or less. In one embodiment, glass 7 can be a glass that does not include V₂O₅.

CoO reduces the transmittance of the glass in the visible range and is also toxic, so it is preferable not to use it. That is, in one embodiment, glass 7 can be a glass that does not contain CoO.

The raw materials for introducing Ge and Ta into glass are expensive. In one embodiment, glass 7 can be a glass that does not contain these as glass components.

Sb (Sb₂O₃), Sn (SnO₂), Ce (CeO₂), and SO₃ are optionally added elements that function as clarifying agents. Among these, Sb (Sb₂O₃) is a clarifying agent having a large clarifying effect.

Sn (SnO₂) and Ce (CeO₂) have a smaller clarifying effect than Sb (Sb₂O₃).

These clarifying agents tend to increase the coloration of the glass when added in large amounts. Therefore, when adding a clarifying agent, Sb (Sb₂O₃) can be added while considering the influence of coloration due to the addition.

For the content of components that can function as clarifying agents described below, the value in the glass composition based on oxides is shown.

The Sb₂O₃ content is expressed as external percentage. That is, when the total content of all glass components as oxides other than Sb₂O₃, SnO₂, CeO₂ and SO₃ is taken as 100.0% by mass, the Sb₂O₃ content can be less than 2.0% by mass, 1.5% by mass or less, 1.2% by mass or less, 1.0% by mass or less, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or less than 0.1% by mass. The content of Sb₂O₃ can be 0% by mass. However, from the viewpoint of promoting the oxidation of the glass and increasing the transmittance in the visible range, the Sb₂O₃ content can be 0.01% by mass or more and also can be 0.02% by mass or more, 0.03% by mass or more, and 0.04% by mass or more, 0.05% by mass or more, 0.06% by mass or more, or 0.08% by mass or more.

The SnO₂ content is also expressed as external percentage. That is, when the total content of all glass components as oxides other than SnO₂, Sb₂O₃, CeO₂ and SO₃ is taken as 100.0% by mass, the content of SnO₂ can be less than 2.0% by mass, less than 1.0% by mass, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or 0.1% by mass. The content of SnO₂ can be 0% by mass. By setting the SnO₂ content within the above ranges, the clarity of the glass can be improved.

The CeO₂ content is also expressed as external percentage. That is, when the total content of all glass components as oxides other than CeO₂, Sb₂O₃, SnO₂, and SO₃ is taken as 100.0% by mass, the CeO₂ content can be less than 2.0% by mass, less than 1.0% by mass, 0.9% by mass or less, 0.8% by mass or less, 0.7% by mass or less, 0.6% by mass or less, 0.5% by mass or less, 0.4% by mass or less, 0.3% by mass or less, 0.2% by mass or less, or less than 0.1% by mass. The CeO₂ content can be 0% by weight. By setting the CeO₂ content within the above ranges, the clarity of the glass can be improved.

SO₃ content is also expressed as external percentage. That is, when the total content of all glass components as oxides other than SO₃, Sb₂O₃, SnO₂, and CeO₂ is taken as 100.0% by mass, the SO₃ content can be less than 2.0% by mass, less than 1.0% by mass, less than 0.5% by mass, or within the range of less than 0.1% by mass. The SO₃ content can be 0% by mass. By setting the content of SO₃ within the above range, the clarity of the glass can be improved.

In one embodiment, glass 7 can satisfy one or more of the following (1) to (4).

Glass 7 can satisfy only one, can satisfy two or more, can satisfy three or more, and can satisfy four of the following (1) to (4).
(1) The ratio of the total content of CaO, SrO and ZnO to the BaO ((CaO+SrO+ZnO)/BaO) content is 0.02 or more,
(2) the ratio of the total content of CaO, SrO and ZnO to the total content of MgO and BaO ((CaO+SrO+ZnO)/(MgO+BaO)) is 0.02 or more,
(3) the ratio of the total content of K₂O+CaO+SrO to the BaO ((K₂O+CaO+SrO)/BaO) content is 0.12 or more, and
(4) the ratio of the total content of K₂O, CaO, SrO and ZnO to the total content of MgO and BaO ((K₂O+CaO+SrO+ZnO)/(MgO+BaO)) is 0.12 or more.

In the glass composition expressed in anion %, glass 7 can contain at least 0 ions as anions, and the content thereof can be 90.0 anion % or more. The present inventors presume that by lowering the O/P ratio in the glass mainly composed of O ions as anions in this way, the absorption by CuO in the red region can be shifted to the longer wavelength side, thereby making it possible to increase the content ratio of CuO and improve the near-infrared cutting ability without reducing the transmittance in the red region. In glass 7, the O ion content in the glass composition expressed by anion % can be 95.0% or more, 98.0% or more, or 99.0% or more. A high proportion of O ions in the anion component is also preferable for suppressing the volatilization during melting of the glass. Suppressing the volatilization during melting of the glass is preferable from the viewpoint of suppressing the generation of striae. In particular, the content of O ions can be 100% from the viewpoint of suppressing the volatilization during melting of the glass, enhancing the productivity, and suppressing the generation of harmful gases during production.

In the glass composition expressed by anion %, glass 7 can contain only O ions as anions in one embodiment and can contain one or more other anions together with O ions in another embodiment. Other anions include F ions, Cl ions, Br ions, I ions, and the like.

In the glass composition expressed by anion % of glass 7, from the viewpoint of improving the uniformity and strength of the glass, the content of F ions is 10.0 anion % or less, can be 5.0 anion % or less, 2.0 anion % or less, or 1.0 anion % or less. In particular, from the viewpoint of suppressing the volatilization during melting of the glass, enhancing the productivity, and suppressing the generation of harmful gas during production, glass 7 can be a glass that does not contain F ions.

<Glass 8>

Next, glass 8 will be explained.

Glass 8 is a near-infrared absorbing glass having a transmittance characteristic in which the external transmittance at a wavelength of 400 nm is 75% or more and the external transmittance at a wavelength of 1200 nm is 7% or less at a thickness of 0.25 mm or less in terms of a thickness at which the external transmittance is 50% at a wavelength of 620 to 650 nm, and having an average linear expansion coefficient at 100° C. to 300° C. (hereinafter also referred to as “a (100° C. to 300° C.)”) of 135×10⁻⁷/K or less.

Rephrasing the wording related to the above transmittance characteristic, where the thickness at which the external transmittance at a wavelength of 400 nm is 75% or more in terms of a thickness at which the external transmittance is 50% at a wavelength of 620 to 650 nm, and at which the external transmittance at a wavelength of 1200 nm is 7% or less in terms of a thickness at which the external transmittance is 50% at a wavelength of 620 to 650 nm is referred to as T1, one or two or more T1 are present within the range of 0.25 mm or less.

In one embodiment, glass 8 can be a near-infrared absorbing glass having a transmittance characteristic in which the external transmittance at a wavelength of 400 nm is 80% or more and the external transmittance at a wavelength of 1200 nm is 5% or less in terms of a thickness at which the external transmittance is 50% at a wavelength of 625 to 650 nm at a thickness of 0.23 mm or less, and having an average linear expansion coefficient at 100° C. to 300° C. of 130×10⁻⁷/K or less.

Rephrasing the wording related to the above transmittance characteristic, where the thickness at which the external transmittance at a wavelength of 400 nm is 80% or more in terms of a thickness at which the external transmittance is 50% at a wavelength of 625 to 650 nm, and at which the external transmittance at a wavelength of 1200 nm is 5% or less in terms of a thickness at which the external transmittance is 50% at a wavelength of 625 to 650 nm is referred to as T2, one or two or more T2 are present within the range of 0.23 mm or less.

In modern compact cameras typified by smartphones and the like, not only the obtained image information digitized, but also the image is reconstructed by performing various computational processing on the image information. For example, it has become mainstream to extract a specific object and adjust the color and contrast of the image. In this case, where color information that is not originally present is input to an imaging element due to reflection of light in the optical element, that information needs to be removed, which is undesirable. In order to achieve both the improvement in performance and the miniaturization, it is desirable that the near-infrared absorbing glass have a thickness of 0.25 mm or less (furthermore, a thickness of 0.23 mm or less). A near-infrared absorbing glass having the above-described transmittance characteristics at such a thickness is preferable from the viewpoint of achieving both the improvement in performance and the miniaturization.

Meanwhile, where the a (100° C. to 300° C.) of the glass is large, after polishing the glass to a thickness of 0.25 mm or less (furthermore, 0.23 mm or less), the glass is likely to break due to thermal shock in the steps of heating before an antireflection film is formed by vapor deposition or the like to reduce reflection loss and cooling after film formation. Meanwhile, reducing the rates at which the glass temperature is raised and lowered in these steps in order to prevent cracking of the glass due to thermal shock leads to a decrease in productivity. In contrast, with glass 8 having an a (100° C. to 300° C.) of 135×10⁻⁷/K or less (or 130×10⁻⁷/K or less), cracking of the glass due to thermal shock can be prevented while maintaining the productivity.

For glass 8, the above transmittance characteristics are obtained by the method of measuring transmittance characteristics described hereinbelow.

The α (100° C. to 300° C.) of the glass is assumed to be measured with a thermomechanical analyzer. For example, α (100° C. to 300° C.) of the glass can be measured by preparing a cylindrical glass sample with a diameter of 5 mm and a length of 20 mm and using a thermomechanical analyzer “TMA4000s” manufactured by BRUKER axs. The temperature rise rate of the sample during the measurement can be set to 4° C./min.

For the glass composition of glass 8, only one of the various items described hereinabove for glasses 1 to 7 can be adopted, or two or more of the various items described hereinabove for glasses 1 to 7 can be adopted in arbitrary combinations. One or more of the items described hereinabove for one of glasses 1 to 7 can be adopted for the glass composition of glass 8 in arbitrary combinations with one or more of the items described hereinabove for other glasses. As an example, one or more of the various items described above for glass 1 and one or more of the various items described above for glass 2 can be combined and adopted for the glass composition of glass 8. Further, as another example, one or more of the various items described above for glass 1, one or more of the various items described above for glass 2, and one or more of the various items described above for glass 3 can be combined and adopted for the glass composition of glass 8. Also, there is no limitation to these examples, and arbitrary combinations are possible.

<Physical Properties of Glass>

Next, the physical properties of glasses 1 to 8 will be explained.

(Transmittance Characteristics)

Glasses 1 to 8 are suitable as glasses for near-infrared cut filters. In the present disclosure and present description, unless otherwise specified, “transmittance” is assumed to refer to external transmittance including the reflection loss.

For the near-infrared cutting ability, the half value λ_{T}50, which is the wavelength at which the transmittance is 50% at a wavelength of 550 nm or more, can be used as an index, and the transmittance T1200 at a wavelength of 1200 nm can also be used as an index.

Glasses 1 to 8 can also exhibit high transmittance in the visible range. For the transmittance in the visible region, the transmittance T400 at a wavelength of 400 nm can be used as an index, and the transmittance T600 at a wavelength of 600 nm can also be used as an index.

The transmittance characteristics of glass are values obtained by the following method.

A glass sample is processed so as to have parallel and optically polished flat surfaces, and the external transmittance at a wavelength of 200 to 1200 nm is measured. The external transmittance also includes the reflection loss of light rays at the sample surface.

A spectral transmittance B/A, including the reflection loss, is calculated, where the intensity of light incident perpendicularly on one optically polished plane is defined as intensity A, and the intensity of light emitted from the other plane is defined as intensity B. The wavelength at which the spectral transmittance is 50% at a wavelength of 550 nm or more is defined as the half value λ_{T}50. The spectral transmittance at a wavelength of 400 nm is denoted by T400, the spectral transmittance at a wavelength of 600 nm is denoted by T600, and the spectral transmittance at a wavelength of 1200 nm is denoted by T1200.

In addition, where the glass to be measured is not a glass with a thickness to be converted, the transmittance at each wavelength A is converted by the following formula A, with the thickness of the glass being d, and various converted values can be obtained from the transmittance characteristics obtained by the conversion.

T(λ)=(1−R(λ))²×exp(logₑ((T₀(λ)/100)/(1−R(λ))²)×d/d₀)×100 Formula A

In formula A, T (λ): converted transmittance (%) at wavelength λ, T₀ (λ): actually measured transmittance (%) at wavelength λ, d: thickness to be converted (mm), do: glass thickness (mm), R(λ): reflectance at wavelength λ that is represented by R(λ)=((n(A)−1)/(n(λ)+1))², and n(λ): refractive index at wavelength λ. Here, the calculation is performed assuming that n(λ)=1.51680 and R(λ)=0.042165 are constants.

A high value of T600, which is the transmittance in the red region, and a low value of T1200, which is the transmittance in the near-infrared region, can mean that both the improvement in the transmittance in the visible region and the improvement in the near-infrared cutting ability are achieved. In addition, a high value of T400, which is the transmittance in the violet region, can also mean that the transmittance in the visible region is improved.

From the above points of view, T400, T600 and T1200 can be within the ranges described below.

T400 can be 70% or more, 71% or more, 72% or more, 73% or more, 74% or more, 75% or more, 76% or more, 77% or more, 78% or more, 79% or more, or 80% or more. T400 can be, for example, 98% or less, 97% or less, or 96% or less, but since it can be said that a higher T400 means better visible light transmissivity, it is also preferable that the values exemplified above be exceeded.

T600 can be 50% or more, 55% or more, 56% or more, 57% or more, 58% or more, 59% or more, 60% or more, 61% or more, 62% or more, 63% or more, 64% or more, 65% or more, 66% or more, 67% or more, 68% or more, 69% or more, 70% or more, 71% or more, 72% or more, 73% or more, 74% or more, or 75% or more. T600 can be, for example, 90% or less, 85% or less, or 80% or less, but since it can be said that a higher T600 means better visible light transmissivity, it is also preferable that the values exemplified above be exceeded.

T1200 can be 30% or less, 29% or less, 28% or less, 27% or less, 26% or less, 25% or less, 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less. T1200 can be, for example, 1% or more, 3% or more, 5% or more, or 7% or more for the purpose of compatibility with the visible light transmittance, but since it can be said that a lower T1200 means a more excellent near-infrared cutting ability, it is also preferable that the value thereof be smaller than the values exemplified above.

In one embodiment, T1200 can be β1% or less.

β1 is calculated by the following formula B1. In formula B1, R is the O/P ratio.

β1=64×R−170 (Formula B1)

In one embodiment, T1200 can also be equal to or less than the numerical values shown in β2, β3, β4, β5, and β6 shown in formulas B2 to B6 below (unit: %).

In the following formulas, R is the O/P ratio.

β2=64×R−175 (Formula B2)

β3=64×R−180 (Formula B3)

β4=80×R−220 (Formula B4)

β5=80×R−224 (Formula B5)

β6=80×R−228 (Formula B6)

The half value λ_{T}50, which is the wavelength at which the spectral transmittance is 50% at a wavelength of 550 nm or more, can be 600 nm or more, 610 nm or more, 613 nm or more, 615 nm or more, 617 nm or more, 620 nm or more, 623 nm or more, 625 nm or more, or 628 nm or more. The half-value λ_{T}50 can be 650 nm or less, 647 nm or less, 645 nm or less, 643 nm or less, 641 nm or less, 640 nm or less, 639 nm or less, or 638 nm or less. Achieving the half-value λ_{T}50, which is the wavelength at which the spectral transmittance is 50% at wavelengths of 550 nm or more, with a predetermined or smaller glass thickness is preferable from the viewpoint of both reducing the glass thickness and improving the near-infrared cutting ability. The predetermined or smaller glass thickness can be 0.25 mm or less.

As will be described later in detail, in one embodiment, glasses 1 to 8 can be used as near-infrared cut filter glasses having a thickness of 0.25 mm or less.

Glasses 1 to 8 can satisfy one or more of the following (a) to (h) as transmittance characteristics for a near-infrared cut filter glass reduced in thickness to 0.25 mm or less. Glasses 1 to 8 can satisfy one or more of the following (a) to (h) and can satisfy two or more as well. By adjusting the glass composition as described above, a glass having favorable transmittance characteristics can be obtained.
(a) The glass thickness at which the wavelength λ_{T}50, at which the external transmittance including the reflection loss at a wavelength of 550 nm or more is 50%, becomes 633 nm is 0.25 mm or less,
with such a thickness, the external transmittance T600 including the reflection loss at a wavelength of 600 nm is 50% or more, and the external transmittance T1200 including the reflection loss at a wavelength of 1200 nm is 30% or less.

Regarding the above (a), the glass thickness at which the wavelength λ_{T}50, at which the external transmittance including the reflection loss at a wavelength of 550 nm or more is 50%, becomes 633 nm can be 0.25 mm or less and can be in the thickness range described hereinbelow for the thickness of the near-infrared cut filter. The same also applies to the following (b), (e) and (f).
(b) The glass thickness at which the wavelength, at which the external transmittance including the reflection loss at a wavelength of 550 nm or more is 50%, becomes 633 nm is 0.25 mm or less,
with such a thickness, the external transmittance T600 including the reflection loss at a wavelength of 600 nm is 50% or more, and the external transmittance T1200 including the reflection loss at a wavelength of 1200 nm is β1% or less. β1 is a value calculated from the following formula B1. In formula B1, R is the O/P ratio of glasses 1 to 8.

β1=64×R−170 (Formula B1)

As described above, T1200 can be β2% or less, β3% or less, β4% or less, β5% or less, or β6% or less.

(c) As a transmittance characteristic in terms of a thickness of 0.16 mm, the wavelength λ_{T}50, at which the external transmittance including the reflection loss is 50%, is in the range of 600 nm to 650 nm, the external transmittance T1200 including the reflection loss at a wavelength of 1200 nm is 30% or less, and the external transmittance T400 including the reflection loss at a wavelength of 400 nm is 70% or more.

(d) As a transmittance characteristic in terms of a thickness of 0.21 mm, the wavelength λ_{T}50, at which the external transmittance including the reflection loss is 50%, is in the range of 600 nm to 650 nm, the external transmittance T1200 including the reflection loss at a wavelength of 1200 nm is 25% or less, and the external transmittance T400 including the reflection loss at a wavelength of 400 nm is 70% or more.

(e) The glass thickness at which the wavelength, at which the external transmittance including the reflection loss at a wavelength of 550 nm or more is 50%, becomes 645 nm is 0.25 mm or less,

with such a thickness, the external transmittance T600 including the reflection loss at a wavelength of 600 nm is 50% or more, and the external transmittance T1200 including the reflection loss at a wavelength of 1200 nm is 30% or less.

(f) The glass thickness at which the wavelength λ_{T}50, at which the external transmittance including the reflection loss at a wavelength of 550 nm or more is 50%, becomes 645 nm is 0.25 mm or less,

with such a thickness, the external transmittance T600 including the reflection loss at a wavelength of 600 nm is 50% or more, and the external transmittance T1200 including the reflection loss at a wavelength of 1200 nm is β1% or less. β1 is a value calculated from formula B described hereinabove.

(g) As a transmittance characteristic in terms of a thickness of 0.23 mm, the wavelength λ_{T}50, at which the external transmittance including the reflection loss is 50%, is in the range of 600 nm to 650 nm, the external transmittance T1200 including the reflection loss at a wavelength of 1200 nm is 18% or less, and the external transmittance T400 including the reflection loss at a wavelength of 400 nm is 70% or more.

(h) As a transmittance characteristic in terms of a thickness of 0.25 mm, the wavelength λ_{T}50, at which the external transmittance including the reflection loss is 50%, is in the range of 600 nm to 650 nm, the external transmittance T1200 including the reflection loss at a wavelength of 1200 nm is 16% or less, and the external transmittance T400 including the reflection loss at a wavelength of 400 nm is 70% or more.

(Weather Resistance)

Glasses 1 to 8 can exhibit excellent weather resistance as a result of having the compositions described above. A haze value measured by a haze meter can also be used as an index for weather resistance. Glass with excellent weather resistance can be exemplified by glass with a haze value of 15% or less as measured by a haze meter conforming to JIS K 7136:2000 after being stored for 90 min under constant temperature and constant humidity at a temperature of 85° C. and a relative humidity of 85%. The haze value can be 0% or 0% or more, 10% or less, 5% or less, or 1% or less.

Also, with regard to weather resistance, in one embodiment, it can be said that glass that is less prone to deliquescence has better weather resistance. An example of a method for evaluating the deliquescence is described in Examples hereinbelow.

(Glass Transition Temperature Tg and Temperature Tm at Which Endothermic Reaction Due to Melting Converges)

The glass transition temperature of glasses 1 to 8 is not particularly limited, but from the viewpoint of increasing the transmittance of the glass in the short wavelength region by improving the meltability of the glass, and from the viewpoint of reducing the load on an annealing furnace and a molding apparatus, the Tg can be 480° C. or lower, 450° C. or lower, 430° C. or lower, 420° C. or lower, 410° C. or lower, 400° C. or lower, or 370° C. or lower. From the viewpoint of enhancing the chemical durability and/or heat resistance of the glass, the Tg can be 250° C. or higher, 260° C. or higher, 270° C. or higher, 280° C. or higher, 290° C. or higher, or 300° C. or higher.

The Tg value of the glass can be controlled by adjusting the contents of Li₂O, Na₂O, K₂O, the total content thereof, the ZnO content, the MgO content, the Al₂O₃ content, and the total content thereof.

The temperature Tm at which the endothermic reaction due to melting of glasses 1 to 8 converges is not particularly limited, but the lower the Tm, the better the meltability, and the glass is unlikely to devitrify even when molding with a higher viscosity is performed. Further, there is a tendency that the better the meltability, the higher the transmittance of the glass in the visible region of the short wavelength region. From these viewpoints, Tm can be 890° C. or lower, 880° C. or lower, 870° C. or lower, 860° C. or lower, 850° C. or lower, 840° C. or lower, 830° C. or lower, 820° C. or lower, 810° C. or lower, 800° C. or lower, 790° C. or lower, 780° C. or lower, 770° C. or lower, 760° C. or lower, 750° C. or lower, 740° C. or lower, 730° C. or lower, 720° C. or lower, 710° C. or lower, 700° C. or lower, 690° C. or lower, 680° C. or lower, 670° C. or lower, 660° C. or lower, or 650° C. or lower. The lower limit of Tm is not particularly limited, but since the weather resistance of the glass tends to decrease when Tm is too low, Tm can be 500° C. or higher, 550° C. or higher, 580° C. or higher, 600° C. or higher, 620° C. or higher, and 640° C. or higher.

The Tm value of the glass can be controlled by adjusting the contents of Li₂O, Na₂O, and K₂O, the total content thereof, the ZnO content, the MgO content, the Al₂O₃ content, and the total content thereof.

For example, a differential scanning calorimeter (DSC8270) manufactured by Rigaku Corp. can be used to measure the glass transition temperature Tg and the temperature Tm at which the endothermic reaction due to melting converges by setting a temperature rise rate to 10° C./min. The measurement temperature range can be set to from room temperature to 1050° C.

(Specific Gravity)

A lightweight near-infrared cut filter is preferable because it leads to weight reduction of elements and devices in which this filter is incorporated. From this point of view, the specific gravity of glasses 1 to 8 can be 3.80 or less, 3.40 or less, 3.35 or less, 3.30 or less, 3.25 or less, 3.20 or less, 3.15 or less, 3.10 or less, 3.05 or less, 3.00 or less, 2.95 or less, 2.90 or less, 2.85 or less, 2.80 or less, 2.75 or less, 2.70 or less, 2.65, or 2.60 or less.

The specific gravity can be, for example, 2.00 or more or 2.40 or more, but since a low specific gravity is preferable from the above point of view, the specific gravity is also preferably below the values exemplified herein. The unit of specific gravity is “g/cc”.

(Molar Volume)

Although the molar volume M/D of the glass is not particularly limited, it is preferable that the molar volume of the glass be smaller from the viewpoint of increasing the near-infrared absorption ability by increasing the amount of CuO per unit volume. The molar volume can be reduced by substituting Li₂O for P₂O₅, La₂O₃, Y₂O₃, Gd₂O₃, and the like, and can be slightly reduced by substituting Li₂O for Al₂O₃, CuO, or Na₂O. Meanwhile, even if Li₂O is substituted for CaO, ZnO, and SrO, the molar volume does not change significantly, and substituting Li₂O for MgO tends to increase the molar volume. By adjusting the glass composition in consideration of these tendencies, the molar volume of the glass can be adjusted. The molar volume can be 45 cc/mol or less, 43 cc/mol or less, 42 cc/mol or less, 41 cc/mol or less, 40 cc/mol or less, 39.5 cc/mol or less, 39.0 cc/mol or less, 38.5 cc/mol or less, 38.0 cc/mol or less, or 37.5 cc/mol or less.

Meanwhile, from the viewpoint of maintaining the weather resistance of the glass, the molar volume can be increased. From this point of view, the molar volume of glasses 1 to 6 can be 34.0 cc/mol or more, and also can be 35.0 cc/mol or more, 36.0 cc/mol or more, 36.5 cc/mol or more, 37.0 cc/mol or more, 37.5 cc/mol or more, 38.0 mol or more, 38.5 cc/mol or more, 39.0 cc/mol or more, and 39.5 cc/mol or more.

<Glass Manufacturing Method>

The above glass can be obtained by preparing, melting, and molding various glass raw materials. The description given below can also be referred with respect to the manufacturing method.

The above near-infrared absorbing glass is suitable as glass for a near-infrared cut filter. In addition, the near-infrared absorbing glass can be applied to optical elements (such as lenses) other than the near-infrared cut filter, and can be also applied to various glass products, and various modifications thereof are possible.

[Near-Infrared Cut Filter]

One aspect of the present disclosure relates to a near-infrared cut filter (hereinafter also simply referred to as “filter”) comprised of the above near-infrared absorbing glass.

The glass that constitutes the above filter is as described above.

A specific example of the method for manufacturing the filter will be described below. However, the following manufacturing method is an example and does not limit the present disclosure.

For the molten glass, glass raw materials such as phosphates, oxides, carbonates, nitrates, sulfates, fluorides, and the like are used, as appropriate, the raw materials are weighed so as to obtain the desired composition, mixed, and then melted at, for example, 800° C. to 1100° C. in a melting vessel such as a platinum crucible. At that time, a lid made of platinum or the like can be used to suppress volatilization of volatile components. Also, the melting can be carried out in the atmosphere, and in order to suppress the change in the valence of Cu, an oxygen atmosphere can be used, or oxygen can be bubbled into the molten glass. The glass in the molten state becomes a homogenized molten glass melt with the amount of bubbles reduced by agitation and clarifying (or free of bubbles). It is also possible to obtain a glass by clarifying the glass at 900° C. to 1100° C. and then reducing the glass temperature to 800° C. to 1000° C. in order to accelerate the oxidation of the glass. However, it is not desirable for the melting temperature or clarifying temperature to be lower than the liquidus temperature of the glass for a long period of time.

After stirring and clarifying the glass in the molten state, the glass is poured out, slowly cooled, and then molded into a desired shape. When pouring out the glass, it is preferable to lower the temperature to a temperature near the liquidus temperature to increase the viscosity of the glass, since convection of the poured-out glass is less likely to occur and striae are less likely to occur. As the annealing rate, a rate between −50° C./hr and −1° C./hr can be selected, and −30° C./hr and −10° C./hr can also be selected.

As a method for molding glass, known methods such as casting, pipe flow, rolling, and pressing can be used. The molded glass is transferred to an annealing furnace preheated to near the glass transition point and annealed to room temperature. Thus, a near-infrared cut filter can be manufactured.

An example of the molding method is described below. A casting mold is prepared which is composed of a flat and horizontal bottom surface, a pair of side walls opposing each other in parallel across the bottom surface, and a barrier plate closing one of the openings positioned between the pair of side walls. A homogenized molten glass is cast into this casting mold from a platinum alloy pipe at a constant outflow speed. The molten glass that has been poured in spreads in the mold and is molded into a glass plate that is regulated to a constant width by the pair of side walls. The molded glass plate is continuously pulled out from the opening of the casting mold. By appropriately setting molding conditions such as the shape and size of the casting mold and the outflow speed of the molten glass, a large and thick glass block can be molded. The glass molded body that has been molded is transferred to the annealing furnace preheated to near the glass transition temperature and slowly cooled to room temperature. The glass molded body from which strain has been removed by annealing is subjected to machining such as slicing, grinding, and polishing. Thus, it is possible to obtain a near-infrared cut filter having a shape according to the application such as a plate-like shape, a lens-like shape, or the like. Alternatively, a method of molding a preform comprised of the glass, heating and softening the preform, and press molding (in particular, a precision press molding method by which the final product is press molded without mechanical processing such as grinding and polishing on the optical function surface) and the like can also be used. An optical multilayer film can be formed on the surface of the filter as necessary.

The above near-infrared cut filter can have both excellent near-infrared cutting ability and high transmittance in the visible range. With such a near-infrared cut filter, it is possible to satisfactorily correct the color sensitivity of a semiconductor imaging device.

Also, the above near-infrared cut filter can be applied to an imaging device by combining the filter with a semiconductor image sensor. In a semiconductor image sensor, a semiconductor imaging element such as a CCD or a CMOS is mounted in a package, and a light-receiving section is covered with a translucent member. The near-infrared cut filter can also serve as a translucent member, or the translucent member can be configured to be separate from the near-infrared cut filter.

The imaging device can also include a lens for forming an image of a subject on the light receiving surface of the semiconductor image sensor, or an optical element such as a prism.

Further, with the above near-infrared cut filter, it is possible to provide an imaging device capable of obtaining an image of excellent image quality with good color sensitivity correction.

In one embodiment, the above near-infrared cut filter can be a near-infrared cut filter with a thickness of 0.25 mm or less. In recent years, with the advent of smartphones, there has been a remarkable tendency to reduce the thickness of cameras with imaging elements, and along with this tendency, near-infrared cut filters have also been desired to exhibit performance with a smaller thickness. The above near-infrared cut filter is suitable as such a near-infrared cut filter. The thickness of the near-infrared cut filter can be 0.24 mm or less, 0.23 mm or less, 0.22 mm or less, 0.21 mm or less, 0.20 mm or less, 0.19 mm or less, 0.18 mm or less, 0.17 mm or less, 0.16 mm or less, 0.15 mm or less, 0.14 mm or less, 0.13 mm or less or 0.12 mm or less. The thickness of the above near-infrared cut filter can be, for example, 0.21 mm or 0.11 mm. Moreover, the thickness of the above near-infrared cut filter can be, for example, 0.50 mm or more, but is not limited to this. In the present disclosure and the present description, the term “thickness” refers to the thickness of the sample in the region where the transmittance is measured, and can be measured with a thickness gauge, micrometer, or the like. For example, the thickness can be measured at approximately the center of the position through which the transmitted light passes, or the thickness can be measured at a plurality of points within the spot of the transmitted light and the average value thereof can be taken.

The above description related to glasses 1 to 8 can be referred to for the transmittance characteristics of the above near-infrared cut filter. In addition, the above description related to glasses 1 to 8 can be also referred to for the physical properties of the above near-infrared cut filter.

### EXAMPLES

The present disclosure will be described in more detail below by way of examples. However, the present disclosure is not limited to the examples.

### Examples 1 to 39, Comparative Examples 1 to 3

As glass raw materials, phosphates, fluorides, carbonates, nitrates, oxides, and the like were weighed and mixed so as to obtain 150 g to 300 g of glasses having the compositions shown in Table 1, placed in a platinum crucible or a quartz crucible, melted at 800° C. to 1000° C. for 80 min to 100 min, stirred to degas and homogenized, poured into a preheated mold, and molded into a predetermined shape. The obtained glass molded bodies were transferred to an annealing furnace heated to around the glass transition temperature and annealed to room temperature. Test pieces were cut out from the obtained glasses, both sides were mirror-polished to a thickness of about 0.2 mm, and various evaluations were performed by the following methods.

Comparative Example 1 is a glass having the composition of Example 5 of JP-A-2019-38719 (PTL 1).

Comparative Example 2 is a glass having the composition of Example 5 of CN110255897 (PTL2).

Comparative Example 3 is a glass having the composition of Example 10 of JP-A-55-3336 (PTL 3).

[Evaluation Methods]

### <Transmittance Characteristics>

The transmittance of each test piece at wavelengths of 200 to 1200 nm was measured using a spectrophotometer. From the measurement results, half value (unit: nm), T400, T600, and T1200 (unit: %) were obtained as values in terms of half-value 645 nm, in terms of half-value 633 nm, in terms of a thickness 0.16 mm, in terms of a thickness 0.21 mm, in terms of a thickness 0.23 mm, and in terms of a thickness 0.25 mm.

In addition, from the measurement results obtained by measuring the transmittance of each test piece at a wavelength of 200 to 1200 nm using a spectrophotometer, the following transmittance characteristics were obtained:
the external transmittance at a wavelength of 400 nm and the external transmittance at a wavelength of 1200 nm in terms of a thickness at which the external transmittance becomes 50% at a wavelength of 620 nm to 650 nm at a thickness of 0.25 nm or less, and
the external transmittance at a wavelength of 400 nm and the external transmittance at a wavelength of 1200 nm in terms of a thickness at which the external transmittance becomes 50% at a wavelength of 625 nm to 650 nm at a thickness of 0.23 nm or less.

<Specific Gravity>

The specific gravity was measured by the Archimedes method.

<α (100° C. to 300° C.)>

A cylindrical glass sample with a diameter of 5 mm and a length of 20 mm was prepared, and a (100° C. to 300° C.) was measured using a thermomechanical analyzer “TMA4000s” manufactured by BRUKER axs. The temperature rise rate of the sample during the measurement was set to 4° C./min.

<Molar Volume>

From the measured specific gravity value, the molar volume was calculated by the method described above.

<Evaluation of Weather Resistance>

Each test piece was held in a constant-temperature and constant-humidity tank at a temperature of 85° C. and a relative humidity of 85% for 90 min. After that, using a haze meter conforming to JIS K 7136:2000, the cloudiness of the test piece was quantitatively evaluated as a haze value.

The deliquescence was evaluated according to the following evaluation criteria by observing the state of the polished surface and side rough-polished surface of each test piece after holding for 90 min in a constant-temperature and constant-humidity tank at a temperature of 85° C. and a relative humidity of 85%.

∘: None of the “stickiness of polished surface”, “transmittance change”, and “color change (darkening) due to moisture on the side rough-polished surface” was observed.

x: One or more of “stickiness of polished surface”, “transmittance change”, and “color change (darkening) due to moisture on side rough-polished surface” was confirmed.

The above results are shown in the table below.

TABLE 1-1

[symbol]

[symbol]

indicates data missing or illegible when filed

TABLE 2-4

| | | | | | | Total | | | | | | |
|---|---|---|---|---|---|---|---|---|---|---|---|---|
| | | | | | | content of | | | | | | |
| Ex. | Molar | | | Number | | oxides of | | | P₂O₃: | | | |
| Comp. | molecular | Specific | Molar | of main | | main | O ion | MgO: | BaO: | | | |
| Ex. | weight | gravity | volume | cation | O/P | cations | content | Al₂O₃ | CaO | | O | O(P)— |
| No. | M(g/mol) | (g/cc) | (cc/mol) | components | ratio | (mo %) | (anion %) | (mol %) | (mol %) | O(P) | (others) | O(others) |
| Ex. 1 | 129.36 | 3.40 | 38.047 | 6 | 3.000 | 100.00 | 100.00 | 2.60 | 90.50 | 263.00 | 52.60 | 210.40 |
| Ex. 2 | 127.15 | 3.42 | 37.223 | 7 | 2.998 | 100.00 | 100.00 | 2.60 | 88.80 | 263.50 | 52.50 | 211.00 |
| Ex. 3 | 126.33 | 3.25 | 38.872 | 7 | 2.998 | 100.00 | 100.00 | 2.60 | 85.80 | 263.50 | 52.50 | 211.00 |
| Ex. 4 | 115.10 | 5.39 | 34.839 | 8 | 5.000 | 100.00 | 100.00 | 1.50 | 81.20 | 257.50 | 51.50 | 206.00 |
| Ex. 5 | 127.12 | 3.39 | 37.499 | 9 | 3.043 | 100.00 | 100.00 | 1.80 | 92.33 | 251.32 | 54.63 | 196.59 |
| Ex. 6 | 131.25 | 3.32 | 39.536 | 6 | 3.000 | 100.00 | 100.00 | 2.58 | 93.22 | 262.85 | 52.55 | 210.30 |
| Ex. 7 | 125.94 | 3.39 | 37.445 | 8 | 2.999 | 100.00 | 100.00 | 2.62 | 88.77 | 263.28 | 52.56 | 210.72 |
| Ex. 8 | 125.58 | 3.21 | 39.464 | 8 | 2.999 | 100.00 | 100.00 | 2.62 | 88.73 | 263.28 | 52.56 | 210.72 |
| Ex. 9 | 128.15 | 3.24 | 39.582 | 8 | 2.990 | 100.00 | 100.00 | 1.60 | 85.99 | 264.38 | 51.86 | 212.52 |
| Ex. 10 | 125.88 | 5.19 | 39.461 | 8 | 2.990 | 100.00 | 100.00 | 1.60 | 85.80 | 264.41 | 51.85 | 212.58 |
| Ex. 11 | 123.51 | 3.15 | 39.208 | 9 | 2.990 | 100.00 | 100.00 | 1.60 | 84.13 | 264.38 | 51.86 | 317.52 |
| Ex. 12 | 128.75 | 3.22 | 39.995 | 6 | 3.000 | 100.00 | 100.00 | 2.60 | 95.47 | 262.98 | 52.56 | 210.42 |
| Ex. 13 | 128.88 | 3.40 | 37.907 | 6 | 3.000 | 100.00 | 100.00 | 2.58 | 90.53 | 262.76 | 52.57 | 210.18 |
| Ex. 14 | 125.47 | 3.38 | 37.415 | 7 | 3.000 | 100.00 | 100.00 | 2.61 | 88.85 | 263.01 | 52.58 | 210.43 |
| Ex. 15 | 215.84 | 3.06 | 33.182 | 9 | 3.000 | 100.00 | 100.00 | 7.22 | 75.18 | 258.44 | 51.69 | 206.75 |
| Ex. 16 | 120.25 | 3.03 | 39.685 | 9 | 3.000 | 100.00 | 100.00 | 5.60 | 81.41 | 258.44 | 51.69 | 206.75 |
| Ex. 17 | 120.77 | 3.06 | 50.468 | 9 | 3.000 | 100.00 | 100.00 | 5.60 | 81.42 | 258.44 | 51.69 | 206.75 |
| Ex. 18 | 119.73 | 3.01 | 39.775 | 9 | 3.000 | 100.00 | 100.00 | 5.60 | 81.42 | 258.44 | 51.69 | 206.75 |
| Ex. 19 | 116.00 | 2.98 | 38.925 | 9 | 3.000 | 100.00 | 100.00 | 7.22 | 78.17 | 258.44 | 51.69 | 206.75 |
| Ex. 20 | 115.04 | 2.98 | 38.604 | 9 | 3.000 | 100.00 | 100.00 | 7.22 | 78.17 | 258.45 | 51.59 | 206.75 |
| Ex. 21 | 118.98 | 3.03 | 39.255 | 9 | 3.000 | 100.00 | 100.00 | 5.60 | 81.41 | 258.44 | 51.69 | 206.75 |
| Ex. 22 | 117.73 | 3.00 | 30.259 | 9 | 3.000 | 100.00 | 100.00 | 5.60 | 81.42 | 258.44 | 51.69 | 206.75 |
| Ex. 23 | 118.99 | 3.02 | 39.401 | 8 | 3.000 | 100.00 | 100.00 | 1.70 | 81.42 | 258.44 | 51.69 | 206.75 |
| Ex. 24 | 122.75 | 3.11 | 39.479 | 8 | 3.000 | 100.00 | 100.00 | 1.70 | 85.31 | 258.44 | 51.69 | 206.75 |
| Ex. 25 | 120.35 | 3.02 | 39.853 | 8 | 3.000 | 100.00 | 100.00 | 2.59 | 82.65 | 252.85 | 52.57 | 210.25 |
| Ex. 26 | 120.84 | 3.07 | 39.363 | 9 | 3.000 | 100.00 | 100.00 | 1.70 | 81.42 | 258.44 | 51.69 | 206.75 |
| Ex. 27 | 119.22 | 3.04 | 39.217 | 10 | 2.999 | 100.00 | 100.00 | 1.47 | 81.72 | 259.39 | 51.75 | 207.64 |
| Ex. 28 | 119.40 | 3.06 | 39.019 | 9 | 3.000 | 100.00 | 100.00 | 1.46 | 81.07 | 257.20 | 57.44 | 205.75 |
| Ex. 29 | 120.37 | 3.07 | 39.209 | 11 | 3.004 | 100.00 | 100.00 | 1.45 | 81.37 | 258.14 | 51.99 | 206.15 |
| Ex. 30 | 115.10 | 2.79 | 41.613 | 7 | 3.020 | 100.00 | 100.00 | 5.28 | 77.99 | 263.20 | 54.90 | 208.30 |
| Ex. 31 | 120.52 | 2.94 | 40.992 | 8 | 3.020 | 100.00 | 100.00 | 4.89 | 83.00 | 253.92 | 54.21 | 209.51 |
| Ex. 32 | 125.20 | 3.10 | 40.387 | 8 | 3.020 | 100.00 | 100.00 | 3.90 | 88.24 | 264.43 | 53.54 | 210.90 |
| Ex. 33 | 118.16 | 3.00 | 39.388 | 10 | 3.000 | 100.00 | 100.00 | 2.53 | 79.78 | 250.42 | 52.16 | 208.25 |
| Ex. 34 | 118.01 | 3.00 | 39.337 | 10 | 3.000 | 100.00 | 100.00 | 2.95 | 78.85 | 260.47 | 52.13 | 208.34 |
| Ex. 35 | 121.94 | 3.08 | 39.592 | 10 | 3.000 | 100.00 | 100.00 | 2.96 | 83.71 | 262.01 | 52.40 | 209.52 |
| Ex. 36 | 125.87 | 3.16 | 39.832 | 10 | 3.000 | 100.00 | 100.00 | 2.96 | 88.54 | 263.55 | 52.65 | 210.91 |
| Ex. 37 | 114.63 | 2.81 | 38.900 | 7 | 3.000 | 100.00 | 100.00 | 5.65 | 79.74 | 269.12 | 54.03 | 215.09 |
| Ex. 38 | 119.69 | 2.96 | 38.900 | 7 | 3.000 | 100.00 | 100.00 | 4.77 | 94.31 | 257.50 | 53.66 | 213.84 |
| Ex. 39 | 124.97 | 3.11 | 38.900 | 7 | 3.000 | 100.00 | 100.00 | 3.77 | 89.00 | 266.50 | 53.22 | 213.28 |
| Comp. | 113.93 | 1.43 | 33.215 | 7 | 3.035 | 100.00 | 100.00 | 10.80 | 67.10 | 260.00 | 55.50 | 204.40 |
| Ex. 1 | | | | | | | | | | | | |
| Comp. | 108.16 | 3.33 | 31.900 | 6 | 2.998 | 98.50 | 100.00 | 11.70 | 72.10 | 201.50 | 55.00 | 225.70 |
| Ex. 2 | | | | | | | | | | | | |
| Comp. | 112.82 | 3.43 | 32.892 | 6 | 2.993 | 98.70 | 100.00 | 5.00 | 74.70 | 278.50 | 54.90 | 223.60 |
| Ex. 3 | | | | | | | | | | | | |

TABLE 3-1

| | A [symbol] | A [symbol] | | α [symbol] | α [symbol] | C-3200 × | C-3478 × |
|---|---|---|---|---|---|---|---|
| Ex. | (O(P)—O | (O(P)—O | C | 70400 × | 75522 × | exp | exp |
| Comp.Ex. | (others)) × | (others)) × | (mmol/ | exp | exp | (−2.278 × | (−2.278 × |
| No. | Cu | C | cc) | (−2.855 × R) | (−2.855 × R) | R) | R) |
| Ex. 1 | 3429.52 | 901.39 | 4.28 | 13.42 | 14.59 | 0.84 | 0.54 |
| Ex. 2 | 3481.50 | 935.31 | 4.43 | 13.50 | 14.67 | 0.97 | 0.67 |
| Ex. 3 | 3734.70 | 960.77 | 4.55 | 13.50 | 14.67 | 1.09 | 0.79 |
| Ex. 4 | 3769.80 | 1082.08 | 5.25 | 13.42 | 14.59 | 1.81 | 1.51 |
| Ex. 5 | 4225.57 | 1126.88 | 5.73 | 11.86 | 12.89 | 2.61 | 2.34 |
| Ex. 6 | 3383.95 | 855.93 | 4.07 | 13.43 | 14.60 | 0.62 | 0.32 |
| Ex. 7 | 3463.12 | 924.87 | 4.39 | 13.46 | 14.63 | 0.94 | 0.64 |
| Ex. 8 | 3463.12 | 877.54 | 4.16 | 13.46 | 14.63 | 0.71 | 0.41 |
| Ex. 9 | 3507.18 | 886.49 | 4.17 | 13.80 | 15.00 | 0.65 | 0.34 |
| Ex. 10 | 3508.25 | 889.03 | 4.18 | 13.80 | 15.00 | 0.66 | 0.35 |
| Ex. 11 | 3507.28 | 894.52 | 4.21 | 13.80 | 15.00 | 0.68 | 0.38 |
| Ex. 12 | 3587.01 | 896.87 | 4.26 | 13.43 | 14.50 | 0.81 | 0.52 |
| Ex. 13 | 3565.04 | 940.47 | 4.47 | 13.41 | 14.58 | 1.03 | 0.73 |
| Ex. 14 | 3683.62 | 984.50 | 4.68 | 13.43 | 14.50 | 1.23 | 0.93 |
| Ex. 15 | 3019.76 | 790.89 | 3.83 | 13.42 | 14.59 | 0.38 | 0.08 |
| Ex. 16 | 3019.71 | 760.90 | 3.68 | 13.42 | 14.58 | 0.24 | −0.06 |
| Ex. 17 | 3019.70 | 765.10 | 3.70 | 13.42 | 14.59 | 0.26 | −0.04 |
| Ex. 18 | 3019.72 | 759.78 | 3.67 | 13.42 | 14.53 | 0.23 | −0.07 |
| Ex. 19 | 3254.64 | 836.12 | 4.04 | 13.42 | 14.59 | 0.60 | 0.30 |
| Ex. 20 | 3523.08 | [symbol] | 4.41 | 13.42 | 14.59 | 0.97 | 0.67 |
| Ex. 21 | 3523.02 | 897.22 | 4.34 | 13.42 | 14.59 | 0.89 | 0.60 |
| Ex. 22 | 3858.57 | 982.84 | 4.75 | 13.42 | 14.59 | 1.31 | 1.01 |
| Ex. 23 | 3690.83 | 936.73 | 4.53 | 13.42 | 14.59 | 1.09 | 0.79 |
| Ex. 24 | 3690.75 | 034.86 | 4.52 | 13.42 | 14.59 | 1.08 | 0.78 |
| Ex. 25 | 3796.88 | 952.71 | 4.53 | 13.42 | 14.59 | 1.09 | 0.79 |
| Ex. 26 | 3690.78 | 937.63 | 4.53 | 13.42 | 14.59 | 1.09 | 0.79 |
| Ex. 27 | 3821.58 | 974.48 | 4.69 | 13.47 | 14.64 | 1.24 | 0.94 |
| Ex. 28 | 3860.90 | 989.48 | 4.81 | 13.42 | 14.58 | 1.36 | 3.06 |
| Ex. 29 | 3882.27 | 990.14 | 4.80 | 13.29 | 14.44 | 1.39 | 1.09 |
| Ex. 30 | 4822.92 | 1158.99 | 5.56 | 12.58 | 13.78 | 2.27 | 1.99 |
| Ex. 31 | 4450.54 | 1088.15 | 5.19 | 12.68 | 13.78 | 1.90 | 1.61 |
| Ex. 32 | 4099.84 | 1015.14 | 4.81 | 12.68 | 13.78 | 1.52 | 1.24 |
| Ex. 33 | 4359.81 | 1106.89 | 5.31 | 13.42 | 14.59 | 1.87 | 1.57 |
| Ex. 34 | 4174.41 | 1061.19 | 5.09 | 13.42 | 14.59 | 1.65 | 1.35 |
| Ex. 35 | 4035.12 | 1019.18 | 4.86 | 13.42 | 14.59 | 1.42 | 1.12 |
| Ex. 36 | 3895.42 | 977.97 | 4.64 | 13.42 | 14.59 | 1.19 | 0.89 |
| Ex. 37 | 4134.06 | 1062.74 | 4.94 | 13.42 | 14.59 | 1.50 | 1.20 |
| Ex. 38 | 4009.54 | 1030.73 | 4.82 | 13.42 | 14.59 | 1.38 | 1.08 |
| Ex. 39 | 3877.39 | 996.76 | 4.67 | 13.42 | 14.59 | 1.23 | 0.93 |
| Comp.Ex. 1 | 2350.60 | 707.70 | 3.46 | 12.15 | 13.22 | 0.28 | 0.00 |
| Comp.Ex. 2 | 3001.81 | 940.84 | 4.17 | 13.59 | 14.78 | 0.69 | 0.39 |
| Comp.Ex. 3 | 4248.40 | 1291.61 | 5.78 | 13.70 | 14.89 | 2.27 | 1.97 |

[symbol]

indicates data missing or illegible when filed

TABLE 4-1

| | | | | | | (3 × Al₂O₃ + | |
|---|---|---|---|---|---|---|---|
| | | | | | (3 × Al₂O₃ + | Y₂O₃ + | |
| | | | | | Y₂O₃ + | La₂O₃ + | |
| | | | | Al₂O₃ + | La₂O₃ + | Gd₂O₃ + | O ion |
| | | Li₂O + | | Y₂O₃ + | Gd₂O₃ + | BaO/3 + | (Coefficient |
| | B₂O₃ + | Na₂O + | Na₂O + | La₂O₃ + | [symbol] (CaO + | (CaO + SiO)/ | of oxide × |
| | SiO₂ | K₂O | K₂O | Gd₂O₃ | SrO)/6) | 6)/(P₂O₃ + | mol % of |
| | (mol %) | (mol %) | (mol %) | (mol %) | (mol %) | BaO + CuO) | cation) |
| Ex. 1 | 0.00 | 2.70 | 2.70 | 2.60 | 15.00 | 0.155 | 315.60 |
| Ex. 2 | 0.00 | 4.30 | 2.70 | 2.60 | 14.33 | 0.161 | 316.00 |
| Ex. 3 | 0.00 | 4.30 | 2.80 | 2.60 | 13.93 | 0.157 | 316.00 |
| Ex. 4 | 0.00 | 3.60 | 6.50 | 1.50 | 9.75 | 0.120 | 309.00 |
| Ex. 5 | 0.00 | 2.01 | 1.21 | 2.46 | 12.92 | 0.178 | 305.95 |
| Ex. 6 | 0.00 | 1.09 | 1.09 | 2.58 | 15.91 | 0.232 | 315.40 |
| Ex. 7 | 0.00 | 4.30 | 2.70 | 2.62 | 14.43 | 0.204 | 315.84 |
| Ex. 8 | 0.00 | 4.30 | 2.70 | 2.62 | 14.43 | 0.204 | 315.84 |
| Ex. 9 | 0.00 | 4.32 | 2.72 | 2.38 | 12.11 | 0.171 | 316.23 |
| Ex. 10 | 0.00 | 4.32 | 2.72 | 2.38 | 11.05 | 0.158 | 316.26 |
| Ex. 11 | 0.00 | 4.32 | 2.72 | 2.38 | 11.31 | 0.159 | 316.24 |
| Ex. 12 | 0.00 | 2.68 | 2.68 | 2.60 | 14.72 | 0.211 | 315.54 |
| Ex. 13 | 0.00 | 2.66 | 2.55 | 2.58 | 14.73 | 0.212 | 315.33 |
| Ex. 14 | 0.00 | 4.27 | 2.69 | 2.61 | 14.06 | 0.195 | 315.55 |
| Ex. 15 | 0.00 | 8.93 | 7.73 | 1.70 | 10.02 | 0.148 | 310.13 |
| Ex. 16 | 0.00 | 2.93 | 7.71 | 1.70 | 10.82 | 0.160 | 310.13 |
| Ex. 17 | 0.00 | 8.93 | 7.71 | 1.70 | 10.82 | 0.160 | 310.13 |
| Ex. 18 | 0.00 | 8.93 | 7.71 | 1.70 | 10.82 | 0.160 | 310.13 |
| Ex. 19 | 0.00 | 8.93 | 7.71 | 1.70 | 9.63 | 0.140 | 310.13 |
| Ex. 20 | 0.00 | 8.93 | 7.71 | 1.70 | 8.20 | 0.131 | 310.13 |
| Ex. 21 | 0.00 | 8.93 | 7.71 | 1.70 | 10.01 | 0.143 | 310.13 |
| Ex. 22 | 0.00 | 2.93 | 7.71 | 1.70 | 9.47 | 0.132 | 310.13 |
| Ex. 23 | 0.00 | 8.93 | 7.71 | 1.70 | 10.39 | 0.147 | 310.13 |
| Ex. 24 | 0.00 | 8.93 | 7.71 | 1.70 | 11.04 | 0.156 | 310.13 |
| Ex. 25 | 0.00 | 9.03 | 7.80 | 2.59 | 12.71 | 0.177 | 315.42 |
| Ex. 26 | 0.00 | 8.93 | 7.71 | 1.70 | 10.39 | 0.147 | 310.13 |
| Ex. 27 | 0.00 | 8.71 | 6.68 | 1.83 | 9.85 | 0.136 | 311.15 |
| Ex. 28 | 0.00 | 8.90 | 6.63 | 1.46 | 9.41 | 0.130 | 308.64 |
| Ex. 29 | 0.00 | 8.93 | 6.66 | 1.83 | 9.69 | 0.133 | 310.13 |
| Ex. 30 | 0.00 | 14.80 | 14.80 | 3.78 | 12.396 | 0.16 | 318.096 |
| Ex. 31 | 0.00 | 11.28 | 10.84 | 3.50 | 13.625 | 0.16 | 318.028 |
| Ex. 32 | 0.00 | 7.45 | 5.58 | 3.23 | 15.049 | 0.17 | 317.968 |
| Ex. 33 | 0.00 | 13.22 | 12.09 | 2.14 | 9.365 | 0.12 | 312.579 |
| Ex. 34 | 0.00 | 12.50 | 10.99 | 2.13 | 9.564 | 0.12 | 312.594 |
| Ex. 35 | 0.00 | 9.57 | 8.14 | 2.42 | 11.885 | 0.14 | 314.412 |
| Ex. 36 | 0.00 | 6.64 | 5.29 | 2.70 | 14.197 | 0.16 | 316.204 |
| Ex. 37 | 0.00 | 14.59 | 5.58 | 3.94 | 14.043 | 0.18 | 323.147 |
| Ex. 38 | 0.00 | 10.88 | 4.52 | 3.60 | 14.819 | 0.18 | 321.156 |
| Ex. 39 | 0.00 | 7.20 | 3.52 | 3.27 | 15.665 | 0.18 | 319.718 |
| Comp.Ex. 1 | 0.00 | 16.50 | 16.50 | 3.80 | 13.55 | 0.202 | 315.60 |
| Comp.Ex. 2 | 0.00 | 15.70 | 0.00 | 6.30 | 19.73 | 0.274 | 337.30 |
| Comp.Ex. 31 | 0.30 | 20.00 | 14.30 | 5.00 | 15.00 | 0.187 | 333.40 |

[symbol]

indicates data missing or illegible when filed

TABLE 5-1

[symbol]

[symbol]

indicates data missing or illegible when filed

TABLE 6

| | Weather | Weather | | |
|---|---|---|---|---|
| | resistance | resistance | | |
| Ex. | 85° C.-85% | 85° C.-85% | α | |
| Comp.Ex. | 90 min | 90 min | (100 to | |
| No. | haze (%) | deliquescence | 300° C.) | β 1 |
| Ex.1 | 0.5 | ○ | 115 | 22.0 |
| Ex.2 | 0.3 | ○ | 116 | 21.9 |
| Ex.3 | 0.5 | ○ | 116 | 21.9 |
| Ex.4 | 0.1 | ○ | 120 | 22.0 |
| Ex.5 | 0.1 | ○ | 113 | 24.8 |
| Ex.6 | 0.2 | ○ | 110 | 22.0 |
| Ex.7 | 0.1 | ○ | 114 | 21.9 |
| Ex.8 | 0.5 | ○ | 115 | 21.9 |
| Ex.9 | 0.2 | ○ | 114 | 21.4 |
| Ex.10 | 0.2 | ○ | 117 | 21.4 |
| Ex.11 | 0.2 | ○ | 115 | 21.4 |
| Ex.12 | 0.5 | ○ | 114 | 22.0 |
| Ex.13 | 0.5 | ○ | 115 | 22.0 |
| Ex.14 | 0.5 | ○ | 117 | 22.0 |
| Ex.15 | 0.1 | ○ | 118 | 22.0 |
| Ex.16 | 0.3 | ○ | 117 | 22.0 |
| Ex.17 | 0.2 | ○ | 116 | 22.0 |
| Ex.18 | 0.5 | ○ | 118 | 22.0 |
| Ex.19 | 0.2 | ○ | 117 | 22.0 |
| Ex.20 | 0.1 | ○ | 119 | 22.0 |
| Ex.21 | 0.1 | ○ | 117 | 22.0 |
| Ex.22 | 0.4 | ○ | 116 | 22.0 |
| Ex.23 | 0.2 | ○ | 113 | 22.0 |
| Ex.24 | 0.5 | ○ | 112 | 22.0 |
| Ex.25 | 0.1 | ○ | 114 | 22.0 |
| Ex.26 | 0.3 | ○ | 115 | 22.0 |
| Ex.27 | 0.3 | ○ | 121 | 21.9 |
| Ex.28 | 0.2 | ○ | 120 | 22.0 |
| Ex.29 | 0.3 | ○ | 121 | 22.2 |
| Ex.30 | 0.8 | ○ | 131 | 23.3 |
| Ex.31 | 0.5 | ○ | 125 | 23.3 |
| Ex.32 | 0.4 | ○ | 121 | 23.3 |
| Ex.33 | 0.5 | ○ | 128 | 22.0 |
| Ex.34 | 0.6 | ○ | 130 | 22.0 |
| Ex.35 | 1.0 | ○ | 124 | 22.0 |
| Ex.36 | 2.0 | ○ | 121 | 22.0 |
| Ex.37 | 0.2 | ○ | 120 | 22.0 |
| Ex.38 | 0.1 | ○ | 124 | 22.0 |
| Ex.39 | 0.4 | ○ | 121 | 22.0 |
| Comp.Ex.1 | 0.5 | x | 140 | 24.2 |
| Comp.Ex.2 | 0.8 | x | 104 | 21.7 |
| Comp.Ex.3 | 0.5 | x | 143 | 21.5 |

From the results shown in the above tables, it can be confirmed that each glass of the above Examples had high transmittance in the visible region (purple region to red region) even when reduced in thickness, were excellent in near-infrared cutting ability, and made it possible to suppress the decrease in weather resistance.

In Comparative Example 1, the Cu concentration was less than α₁% and less than α₂%. The glass of Comparative Example 1 could not be thinned to obtain the desired transmittance characteristics.

The glass of Comparative Example 2 had a high T1200 at the reduced thickness.

Since the glass of Comparative Example 3 had a large a (100° C. to 300° C.), the glass was easily cracked as described above.

In addition, the glasses of Comparative Examples 1 to 3 were easily deliquesced because the total content (Li₂O+Na₂O+K₂O) of Li₂O, Na₂O and K₂O exceeded 15 mol %.

Each glass of the above Examples was processed into flat plates having three thicknesses, that is, 0.21 mm, 0.16 mm, and 0.11 mm, to produce near-infrared cut filters. The main surface of the near-infrared cut filter was an optically polished surface. Thus, near-infrared cut filters having excellent near-infrared cutting ability and excellent weather resistance could be obtained. A coat such as an antireflection film can be formed on the surface of the near-infrared cut filter.

### Examples 1-1 to 1-4

As glass raw materials, phosphates, fluorides, carbonates, nitrates, oxides, and the like were weighed and mixed so as to obtain 150 g to 300 g of glasses having the same compositions as in Example 1 described hereinabove, except that the Sb₂O₃ content expressed as external percentage was 0.1% by mass (Example 1-1), 0.5% by mass (Example 1-2), 1.0% by mass (Example 1-3) or 1.5% by mass (Example 1-4). The mixtures were placed in a platinum crucible or a quartz crucible, melted at 800° C. to 1000° C. for 80 min to 100 min, stirred to degas and homogenized, poured into a preheated mold, and molded into a predetermined shape. The obtained glass molded bodies were transferred to an annealing furnace heated to around the glass transition temperature and annealed to room temperature. Test pieces were cut out from the obtained glasses, both sides were mirror-polished to a thickness of about 0.20 mm to about 0.21 mm. Then, transmittance characteristics of each test piece were measured by the above-described method, and T400 (unit: %) was obtained as an external transmittance at a wavelength of 400 nm with a plate thickness at which the external transmittance at 633 nm was 50%. Such T400 was also determined for the glass of Example 1 (without Sb₂O₃ addition).

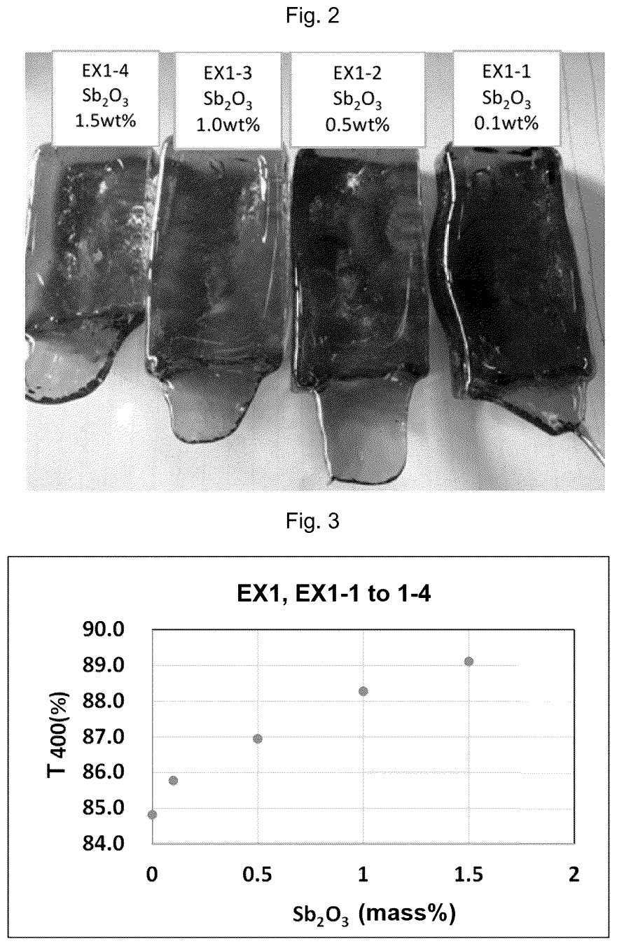

FIG. 2 shows photographs of exterior of the glasses of Examples 1-1 to 1-4. FIG. 3 is a graph in which the value of T400 is plotted against the amount of Sb₂O₃ for the glasses of Example 1 and Examples 1-1 to 1-4.

### Examples 4-1 to 4-4

As glass raw materials, phosphates, fluorides, carbonates, nitrates, oxides, and the like were weighed and mixed so as to obtain 150 g to 300 g of glasses having the same compositions as in Example 4 described hereinabove, except that the Sb₂O₃ content expressed as external percentage was 0.1% by mass (Example 4-1), 0.5% by mass (Example 4-2), 1.0% by mass (Example 4-3) or 1.5% by mass (Example 4-4). The mixtures were placed in a platinum crucible or a quartz crucible, melted at 800° C. to 1000° C. for 80 min to 100 min, stirred to degas and homogenized, poured into a preheated mold, and molded into a predetermined shape. The obtained glass molded bodies were transferred to an annealing furnace heated to around the glass transition temperature and annealed to room temperature. Test pieces were cut out from the obtained glasses, both sides were mirror-polished to a thickness of about 0.20 mm. Then, transmittance characteristics of each test piece were measured by the above-described method, and T400 (unit: %) was obtained as an external transmittance at a wavelength of 400 nm with a plate thickness at which the external transmittance at 633 nm was 50%. Such T400 was also determined for the glass of Example 4 (without Sb₂O₃ addition).

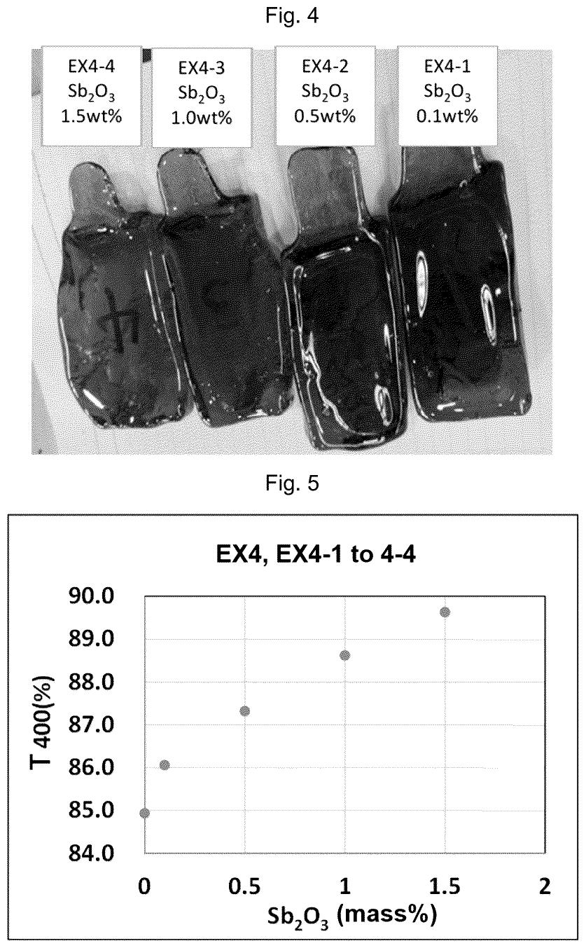

FIG. 4 shows photographs of exterior of the glasses of Examples 4-1 to 4-4. FIG. 5 is a graph in which the value of T400 is plotted against the amount of Sb₂O₃ for the glasses of Example 4 and Examples 4-1 to 4-4.

### Examples 25-1 to 25-4

As glass raw materials, phosphates, fluorides, carbonates, nitrates, oxides, and the like were weighed and mixed so as to obtain 150 g to 300 g of glasses having the same compositions as in Example 25 described hereinabove, except that the Sb₂O₃ content expressed as external percentage was 0.1% by mass (Example 25-1), 0.5% by mass (Example 25-2), 1.0% by mass (Example 25-3) or 1.5% by mass (Example 25-4). The mixtures were placed in a platinum crucible or a quartz crucible, melted at 800° C. to 1000° C. for 80 min to 100 min, stirred to degas and homogenized, poured into a preheated mold, and molded into a predetermined shape. The obtained glass molded bodies were transferred to an annealing furnace heated to around the glass transition temperature and annealed to room temperature. Test pieces were cut out from the obtained glasses, both sides were mirror-polished to a thickness of about 0.21 mm to about 0.22 mm. Then, the transmittance characteristics of each test piece were measured by the above-described method, and T400 (unit: %) was obtained as an external transmittance at a wavelength of 400 nm with a plate thickness at which the external transmittance at 633 nm was 50%. Such T400 was also determined for the glass of Example 25 (without Sb₂O₃ addition).

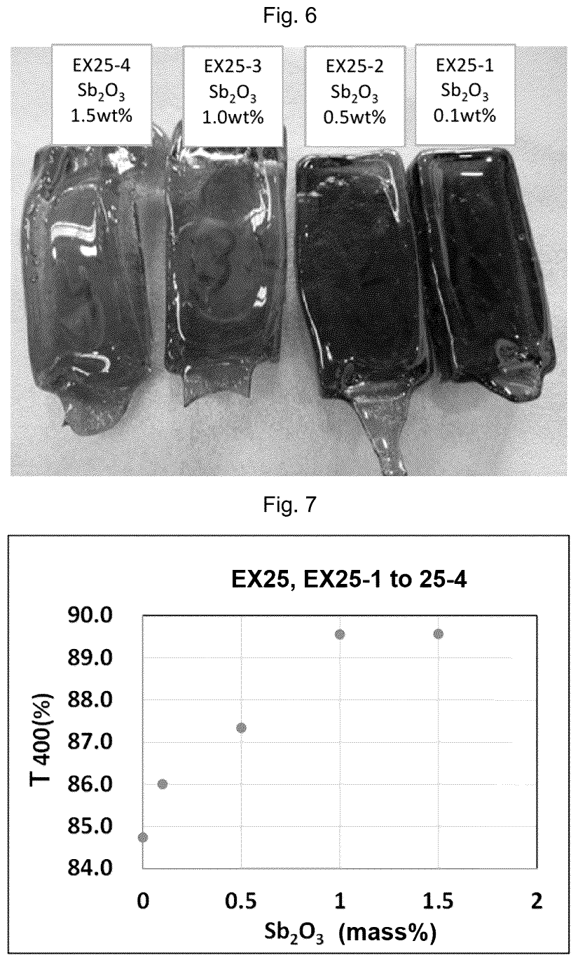

FIG. 6 shows photographs of exterior of the glasses of Examples 25-1 to 25-4. FIG. 7 is a graph in which the value of T400 is plotted against the amount of Sb₂O₃ for the glasses of Example 25 and Examples 25-1 to 25-4.

From the results shown in FIGS. 2 to 7, it can be confirmed that the addition of Sb₂O₃ to the glass is preferable from the viewpoint of promoting the oxidation of the glass and increasing the transmittance in the visible region. In one embodiment, the Sb₂O₃ content expressed as external percentage can be 0.1% by mass or more, 0.5% by mass or more, 1.0% by mass or more, or 1.5% by mass or more.

Finally, the aforementioned aspects are summarized.

According to one aspect, glasses 1 to 6 detailed above are provided.

In one embodiment, glasses 1 to 6 can be glasses having a glass composition expressed in mol % based on oxides in which the ratio of the BaO content to the Li₂O content (BaO/Li₂O) is 1.0 or more, and at least one of the following (1) to (4) are satisfied.
(1) The ratio of the total content of CaO, SrO and ZnO to the BaO content ((CaO+SrO+ZnO)/BaO) is 0.02 or more,
(2) the ratio of the total content of CaO, SrO and ZnO to the total content of MgO and BaO ((CaO+SrO+ZnO)/(MgO+BaO)) is 0.02 or more,
(3) the ratio of the total content of K₂O, CaO and SrO to the BaO content ((K₂O+CaO+SrO)/BaO) is 0.12 or more, and
(4) The ratio of the total content of K₂O, CaO, SrO and ZnO to the total content of MgO and BaO ((K₂O+CaO+SrO+ZnO)/(MgO+BaO)) is 0.12 or more.

In one embodiment, the total content of the oxides of the main cations in the glass compositions of glasses 1 to 6 expressed in mol % based on the oxides can be 90.0% or more.

According to one aspect, glass 7 detailed above is provided.

In one embodiment, glass 7 can be glass that satisfies one or more of the following (1) to (4).
(1) The ratio of the total content of CaO, SrO and ZnO to the BaO content ((CaO+SrO+ZnO)/BaO) is 0.02 or more,
(2) the ratio of the total content of CaO, SrO and ZnO to the total content of MgO and BaO ((CaO+SrO+ZnO)/(MgO+BaO)) is 0.02 or more,
(3) the ratio of the total content of K₂O, CaO and SrO to the BaO content ((K₂O+CaO+SrO)/BaO) is 0.12 or more, and
(4) the ratio of the total content of K₂O, CaO, SrO and ZnO to the total content of MgO and BaO ((K₂O+CaO+SrO+ZnO)/(MgO+BaO)) is 0.12 or more.

According to one aspect, glass 8 detailed above is provided.

In one embodiment, glass 8 can be glass having a transmittance characteristic in which the external transmittance at a wavelength of 400 nm is 80% or more and the external transmittance at a wavelength of 1200 nm is 5% or less in terms of a thickness at which the external transmittance is 50% at a wavelength of 625 to 650 nm at a thickness of 0.23 mm or less, and having an average linear expansion coefficient at 100° C. to 300° C. of 130×10⁻⁷/K or less.

In one embodiment, glasses 1 to 8 can be glasses in which the thickness of the glass at which the half value λ_{T}50, which is the wavelength at which the external transmittance including the reflection loss is 50% at a wavelength of 550 nm or more, is 633 nm is 0.25 mm or less, and at this thickness, the external transmittance T600 including the reflection loss at a wavelength of 600 nm is 50% or more and the external transmittance T1200 including the reflection loss at a wavelength of 1200 nm is 30% or less.

In one embodiment, glasses 1 to 8 can be glasses in which the thickness of the glass at which the half value λ_{T}50, which is the wavelength at which the external transmittance including the reflection loss is 50% at a wavelength of 550 nm or more, is 633 nm is 0.25 mm or less, and at this thickness, the external transmittance T600 including the reflection loss at a wavelength of 600 nm is 50% or more and the external transmittance T1200 including the reflection loss at a wavelength of 1200 nm is β1% or less. β1 is as described above.

In one embodiment, glasses 1 to 8 can be glasses in which as a transmittance characteristic in terms of a thickness of 0.16 mm, the half-value λ_{T}50, which is the wavelength at which the external transmittance including the reflection loss is 50%, is in the range of 600 nm to 650 nm, the external transmittance T1200 including the reflection loss at a wavelength of 1200 nm is 30% or less, and the external transmittance T400 including the reflection loss at a wavelength of 400 nm is 70% or more.

In one embodiment, glasses 1 to 8 can be glasses in which as a transmittance characteristic in terms of a thickness of 0.21 mm, the half-value λ_{T}50, which is the wavelength at which the external transmittance including the reflection loss is 50%, is in the range of 600 nm to 650 nm, the external transmittance T1200 including the reflection loss at a wavelength of 1200 nm is 25% or less, and the external transmittance T400 including the reflection loss at a wavelength of 400 nm is 70% or more.

In one embodiment, glasses 1 to 8 can be glasses in which the thickness of the glass at which the half value λ_{T}50, which is the wavelength at which the external transmittance including the reflection loss is 50% at a wavelength of 550 nm or more, is 645 nm is 0.25 mm or less, and at this thickness, the external transmittance T600 including the reflection loss at a wavelength of 600 nm is 50% or more and the external transmittance T1200 including the reflection loss at a wavelength of 1200 nm is 30% or less.

In one embodiment, glasses 1 to 8 can be glasses in which the thickness of the glass at which the half value λ_{T}50, which is the wavelength at which the external transmittance including the reflection loss is 50% at a wavelength of 550 nm or more, is 645 nm is 0.25 mm or less, and at this thickness, the external transmittance T600 including the reflection loss at a wavelength of 600 nm is 50% or more and the external transmittance T1200 including the reflection loss at a wavelength of 1200 nm is β1% or less. β1 is as described above.

According to one aspect, a near-infrared cut filter comprised of the above near-infrared absorbing glass is provided.

The embodiments disclosed herein should be considered illustrative in all respects and not restrictive. The scope of the present disclosure is indicated by the scope of the claims rather than the above description, and is intended to include all changes within the meaning and scope equivalent to the scope of the claims.

For example, the near-infrared absorbing glass according to one aspect of the present disclosure can be obtained by performing the composition adjustment described in the description with respect to the glass composition exemplified hereinabove.

In addition, it is obviously possible to arbitrarily combine two or more of the matters described as examples or preferred ranges in the description.

What is claimed is:

1. A near-infrared absorbing glass,
which comprises four or more kinds of main cations selected from the group consisting of P ions, Li ions, Cu ions, Al ions, Ba ions, Sr ions, Ca ions, Mg ions, Zn ions, K ions, Na ions, La ions, Gd ions and Y ions, and
comprises P ions, Ba ions and Cu ions as essential cations, wherein
in a glass composition expressed in anion %, a content of O ions is 90.0 anion % or more,
in a glass composition expressed in atomic %, a ratio of a content of O ions to a content of P ions (O ions/P ions) is 3.15 or less,
in a glass composition expressed in mol % based on oxides,
a total content of B₂O₃ and SiO₂ (B₂O₃+SiO₂) is 3.0 mol % or less,
a total content of MgO and Al₂O₃ (MgO+Al₂O₃) is 8.0 mol % or less, and
a total content of Li₂O, Na₂O and K₂O (Li₂O+Na₂O+K₂O) is 15 mol % or less.

2. The near-infrared absorbing glass according to claim 1,
wherein a content of CuO is α₁% or more,
α₁ is a value calculated by the following formula 1:
α₁=70400×exp(−2.855×R) (Formula 1)
in formula 1,
R is the ratio (O ions/P ions).

3. The near-infrared absorbing glass according to claim 1,
wherein the following formula 2 is satisfied:
C−3200×exp(−2.278×R)≥0 (Formula 2)
in formula 2,
C is a CuO content per molar volume of the glass (unit: mmol/cc),
R is the ratio (O ions/P ions).

4. The near-infrared absorbing glass according to claim 1,
wherein A₁ calculated by the following formula 3 is 2500 or more:
A₁={O(P)—O(others)}×Cu (Formula 3)
in formula 3,
O (P) indicates an amount of oxygen that constitutes oxides of P ions in the glass composition based on oxides,
O (others) indicates an amount of oxygen obtained by excluding the O (P) from an amount of oxygen constituting oxides of the main cations in the glass composition based on oxides, and
Cu indicates a CuO content in mol % in the glass composition based on oxides.

5. The near-infrared absorbing glass according to claim 1,
wherein A₂ calculated by the following formula 4 is 700 or more:
A₂={O(P)—O(others)}×C (Formula 4)
in formula 4,
C is a CuO content per molar volume of the glass (unit: mmol/cc),
O (P) indicates an amount of oxygen that constitutes oxides of P ions in the glass composition based on oxides, and
O (others) indicates an amount of oxygen obtained by excluding the O (P) from an amount of oxygen constituting oxides of the main cations in the glass composition based on oxides.

6. The near-infrared absorbing glass according to claim 1,
wherein a content of CuO is α₂% or more,
α₂ is a value calculated by the following formula 5:
α₂₌₇₆₅₂₂×exp(−2.855×R) (Formula 5)
in formula 5,
R is the ratio (O ions/P ions).

7. The near-infrared absorbing glass according to claim 1,
wherein the following formula 6 is satisfied:
C−3478×exp(−2.278×R)≥O (Formula 6)
in formula 6,
C is a CuO content per molar volume of the glass (unit: mmol/cc),
R is the ratio (O ions/P ions).

8. The near-infrared absorbing glass according to claim 1,
wherein, in a glass composition expressed in mol % based on oxides, a ratio of a BaO content to a Li₂O content (BaO/Li₂O) is 1.0 or more, and
at least one of the following (1) to (4) are satisfied:
(1) a ratio of a total content of CaO, SrO and ZnO to the BaO content ((CaO+SrO+ZnO)/BaO) is 0.02 or more,
(2) a ratio of a total content of CaO, SrO and ZnO to a total content of MgO and BaO ((CaO+SrO+ZnO)/(MgO+BaO)) is 0.02 or more,
(3) a ratio of a total content of K₂O, CaO and SrO to a BaO content ((K₂O+CaO+SrO)/BaO) is 0.12 or more, and
(4) a ratio of a total content of K₂O, CaO, SrO and ZnO to a total content of MgO and BaO ((K₂O+CaO+SrO+ZnO)/(MgO+BaO)) is 0.12 or more.

9. The near-infrared absorbing glass according to claim 1,
wherein a total content of oxides of the main cations in the glass composition expressed in mol % based on oxides is 90.0% or more.

10. The near-infrared absorbing glass according to claim 1,
wherein
in a glass composition expressed in mol % based on oxides,
a P₂O₅ content is 40.0 mol % to 65.0 mol %,
a CuO content is 9.0 mol % to 25.0 mol %,
a BaO content is 5.0 mol % to 50.0 mol %,
a total content of Li₂O, Na₂O and K₂O (Li₂O+Na₂O+K₂O) is 1.0 mol % to 15.0 mol %,
a SiO₂ content is 2.0 mol % or less,
a B₂O₃ content is 2.0 mol % or less,
a Al₂O₃ content is 0.5 mol % or more and 7.0 mol % or less,
a Li₂O content is 7.0 mol % or less,
a ZnO content of 10.0 mol % or less,
a PbO content is 2.0 mol % or less,
a ratio of a MgO content to a total content of MgO, CaO, SrO and BaO (MgO/(MgO+CaO+SrO+BaO)) is 0.3 or less,
in a glass composition expressed in atomic %, a ratio of a content of O ions to a content of P ions (O ions/P ions) is 3.15 or less, and
in a glass composition expressed in atomic %, a content of F ions is 10.0 anion % or less.

11. The near-infrared absorbing glass according to claim 10,
which satisfies one or more of the following (1) to (4).
(1) a ratio of a total content of CaO, SrO and ZnO to a BaO content ((CaO+SrO+ZnO)/BaO) is 0.02 or more,
(2) a ratio of a total content of CaO, SrO and ZnO to a total content of MgO and BaO ((CaO+SrO+ZnO)/(MgO+BaO)) is 0.02 or more,
(3) a ratio of a total content of K₂O, CaO and SrO to a BaO ((K₂O+CaO+SrO)/BaO) content is 0.12 or more, and
(4) a ratio of a total content of K₂O, CaO, SrO and ZnO to a total content of MgO and BaO ((K₂O+CaO+SrO+ZnO)/(MgO+BaO)) is 0.12 or more.

12. The near-infrared absorbing glass according to claim 1,
which has a transmittance characteristic in which an external transmittance at a wavelength of 400 nm is 75% or more and an external transmittance at a wavelength of 1200 nm is 7% or less in terms of a thickness at which an external transmittance is 50% at a wavelength of 620 to 650 nm at a thickness of 0.25 mm or less, and
an average linear expansion coefficient at 100° C. to 300° C. of 135×10⁻⁷/K or less.

13. The near-infrared absorbing glass according to claim 12,
which has a transmittance characteristic in which an external transmittance at a wavelength of 400 nm is 80% or more and an external transmittance at a wavelength of 1200 nm is 5% or less in terms of a thickness at which an external transmittance is 50% at a wavelength of 625 to 650 nm at a thickness of 0.23 mm or less, and
an average linear expansion coefficient at 100° C. to 300° C. of 130×10⁻⁷/K or less.

14. The near-infrared absorbing glass according to claim 1,
wherein a thickness of the glass at which a half value λ_{T}50, which is a wavelength at which an external transmittance including a reflection loss is 50% at a wavelength of 550 nm or more, is 633 nm is 0.25 mm or less, and
at the thickness, an external transmittance T600 including a reflection loss at a wavelength of 600 nm is 50% or more and an external transmittance T1200 including a reflection loss at a wavelength of 1200 nm is 30% or less.

15. The near-infrared absorbing glass according to claim 1,
wherein a thickness of the glass at which a half value λ_{T}50, which is a wavelength at which an external transmittance including a reflection loss is 50% at a wavelength of 550 nm or more, is 633 nm is 0.25 mm or less, and at the thickness, an external transmittance T600 including a reflection loss at a wavelength of 600 nm is 50% or more and an external transmittance T1200 including a reflection loss at a wavelength of 1200 nm is β1% or less, wherein 31 is a value calculated from the following formula B1;
β1=64×R−170 (Formula B1)
in formula B1, R is the ratio (O ions/P ions).

16. The near-infrared absorbing glass according to claim 1,
wherein, as a transmittance characteristic in terms of a thickness of 0.16 mm, a half-value λ_{T}50, which is a wavelength at which an external transmittance including a reflection loss is 50%, is in a range of 600 nm to 650 nm, an external transmittance T1200 including a reflection loss at a wavelength of 1200 nm is 30% or less, and an external transmittance T400 including a reflection loss at a wavelength of 400 nm is 70% or more.

17. The near-infrared absorbing glass according to claim 1,
wherein, as a transmittance characteristic in terms of a thickness of 0.21 mm, a half-value λ_{T}50, which is a wavelength at which an external transmittance including a reflection loss is 50%, is in a range of 600 nm to 650 nm, an external transmittance T1200 including a reflection loss at a wavelength of 1200 nm is 25% or less, and an external transmittance T400 including a reflection loss at a wavelength of 400 nm is 70% or more.

18. The near-infrared absorbing glass according to claim 1,
wherein, a thickness of the glass at which a half value λ_{T}50, which is a wavelength at which an external transmittance including a reflection loss is 50% at a wavelength of 550 nm or more, is 645 nm is 0.25 mm or less, and
at the thickness, an external transmittance T600 including a reflection loss at a wavelength of 600 nm is 50% or more and an external transmittance T1200 including a reflection loss at a wavelength of 1200 nm is 30% or less.

19. The near-infrared absorbing glass according to claim 1,
wherein, a thickness of the glass at which a half value λ_{T}50, which is a wavelength at which an external transmittance including a reflection loss is 50% at a wavelength of 550 nm or more, is 645 nm is 0.25 mm or less, and at the thickness, an external transmittance T600 including a reflection loss at a wavelength of 600 nm is 50% or more and an external transmittance T1200 including a reflection loss at a wavelength of 1200 nm is β31% or less, wherein 31 is a value calculated from the following formula B1;
β1=64×R−170 (Formula B1)
in formula B1, R is the ratio (O ions/P ions).

20. A near-infrared cut filter comprised of the near-infrared absorbing glass according to claim 1.
